(19) United States
(12) Patent Application Publication
(10) Pub. No.: US 2015/0193710 A1
(43) Pub. Date: Jul. 9, 2015

(54) ESTABLISHING A PROFESSIONAL RUGBY UNION LEAGUE IN THE U.S. THROUGH THE INTEGRATION OF ONE OR MORE TEAMS FROM AN EXISTING PROFESSIONAL AMERICAN FOOTBALL LEAGUE

(71) Applicant: Andre V. Demarest, Miami Beach, FL (US)

(72) Inventor: Andre V. Demarest, Miami Beach, FL (US)

(21) Appl. No.: 14/586,170

(22) Filed: Dec. 30, 2014

Related U.S. Application Data
(60) Provisional application No. 61/930,128, filed on Jan. 22, 2014.
(60) Provisional application No. 61/923,919, filed on Jan. 6, 2014.

(51) Int. Cl. G06Q 10/06

(52) U.S. Cl. CPC G06Q 10/06313; G06Q 10/063112

(57) ABSTRACT

Described herein are examples of techniques for quickly and efficiently instituting and growing a professional rugby union league in the U.S. through the expansion and integration of one or more team/club organizations from an existing professional American football league (e.g., the NFL), including their available resources such as qualified players from their roster.

### CROSS-REFERENCE TO RELATED APPLICATIONS

The present application claims priority under 35 U.S.C. §119(e) to U.S. Provisional Patent Application Ser. No. 61/923,919, titled “Instituting And Growing A U.S. Professional Rugby Union League Through The Expansion And Integration Of One Or More Team/Club Organizations From An Existing Professional American Football System (NFL), Including Their Available Resources Such As Qualified Players From Their Roster, Into An Existing Non-Professional Rugby Union System (USA Rugby Elite Cup)” and filed on Jan. 6, 2014, and to U.S. Provisional Patent Application Ser. No. 61/930,128, titled “Instituting And Growing A U.S. Professional Rugby Union League Through The Expansion And Integration Of One Or More Team/Club Organizations From An Existing Professional American Football System (NFL), Including Their Available Resources Such As Qualified Players From Their Roster, Into An Existing Non-Professional Rugby Union System (USA Rugby Elite Cup)” and filed on Jan. 22, 2014, the contents of both of which applications are incorporated herein in their entirety.

### BACKGROUND

### Brief History of Non-Professional Rugby Union in the U.S.

The international sport of rugby originated from Rugby School in England where William Webb Ellis is often given credit for the invention in 1823 while playing association football (or “soccer” as it's known in the U.S. today), after he allegedly caught the ball and ran with it in hand towards the opponent's goal. Rugby union or rugby football with its egg/oval shaped ball was initially played in the U.S. in the mid-19^{th} century and gained popularity among prestigious universities. In 1876, Harvard convinced Princeton and Columbia to form the Intercollegiate Football Association (IFA) essentially based on rugby football (or rugby union rules at the time). The game of rugby football itself mainly involves advancing the ball forward toward your opponent's goal line by running with it and evading defenders by passing it off to your teammate(s) behind you (or to the side of you) via a lateral or pitch movement. After 1880, American football emerged as a uniquely different sport from rugby football and became more popular and dominant at the college level during the first half of the 20^{th} century. During this time, the U.S. did win the gold medal in rugby football at the 1920 and 1924 Olympics, but the sport became less and less relevant over the following decades.

There was a resurgence of interest in rugby as a club sport at colleges starting from the 1960's. This development was spearheaded by Catholic institutions, in particular Jesuit universities. For example, during this time Lt. Hans Grauert Memorial Field became the first collegiate field dedicated to the sport of rugby at Fairfield University in Connecticut as it was designed to meet the specific measurement requirements, which are longer and wider than American football fields in total by 10.272 meters and 21.232 meters, respectively.

USA Rugby was founded in 1975 and is the governing body of rugby union in the U.S. In early 1976, the U.S. national team (the Eagles) played against Australia in its first international match since the 1924 Olympics before a crowd of 7,000 fans at Glover Field in Los Angeles, Calif. The first Rugby World Cup was held in 1987 and the U.S. national team participated. The winner receives the William Webb Ellis Cup. The Eagles have participated in 6 of 7 of the Rugby World Cups, including the last one which concluded in late October 2011.

USA Rugby formed a National Collegiate Rugby Championship competition in 1980 for the top college teams in the nation. Starting with the 2011 season, the top level Division I teams were split into the top tier Division I-A (formerly known as the College Premier Division) and the next tier Division I-AA. There are also Division II, III and IV tier levels with the latter two falling under the National Small College Rugby Organization (NSCRO).

The Rugby Super League was a nationwide non-professional or men's club competition, which was founded in 1996 and launched in 1997 with 14 teams. This rugby union league was subsequently renamed and replaced in 2012 by the USA Rugby Elite Cup, which was launched in 2013 with 8 teams. However, this new league lasted just one season and was soon disbanded. Thereafter it was announced that 7 west coast teams, 3 of which formerly competed in the Elite Cup as well as 4 other teams from California, would join the Pacific Rugby Premiership (PRP) in 2014. It was further announced that 5 east coast teams, 4 of which formerly competed in the Elite Cup as well as 1 other team from Massachusetts, would join the American Rugby Premiership (ARP) in 2014. Teams from the PRP and ARP essentially represent the best or consistently highly ranked teams from Division I men's club level, which also separately has a National Championship competition. There are also Division II and III tier men's club levels.

### Current Status and Trends: Non-Professional Rugby Union in the U.S.

According to Sports and Fitness Industry Association, rugby has been the fastest growing U.S. team sport in the last 5 years. Based on a survey at the beginning of 2014, it had the biggest growth rate among team sports for players ages 6 and up. Also, according to Tom Feury, who started youth programs in New Jersey in 1999, “rugby is catching up partly because the sport, which uses no hard helmets or other protective equipment, is more economical and safer than (American) football”. Robert Cantu, a researcher of brain injuries at the Boston University School of Medicine has confirmed that “fewer concussions occur in rugby” because “without pads and without helmets, players are taught to tackle with their arms and shoulders, and keep their head out of the tackle”.

There are different kinds of rugby that also get different kinds of support and attention. For example, in addition to rugby union, there is rugby league and rugby sevens. Certain key distinctions among them, including an update on their current status and trends in the U.S. are as follows:

Rugby league (or rugby league football) consists of 13 players on each side, while rugby union consists of 15 players on each side however both include two 40 minute halves of playing time. In addition there are a number of other differences between rugby league and rugby union specifically related to tackling opponents, point scoring, pitch size and other rules. In the U.S., up to 11 non-professional or men's club teams from the east coast compete in a summer season (from early June to late August) that is governed by the USA Rugby League (USARL), formerly known as the American National Rugby League (AMNRL) and not to be confused with the aforementioned USA Rugby. The championship final match in 2014 was held in Jacksonville, Fla., and this event did not have live network broadcasting in the US (other than online streaming via a live webcast). Meanwhile, the U.S. national rugby team (the Tomahawks) for rugby league recently participated for the first time in the 2013 Rugby League World Cup, which took place in the British Isles and France from Oct. 26, to Nov. 30, 2013. This team reached the quarter-finals but lost to Australia 62-0. This event did not have live network broadcasting in the US (other than online streaming via a live webcast) as Premier Sports had the rights to full live coverage for broadcasting the event from the United Kingdom.

Rugby sevens consists of only 7 players on each side which compete against each other in matches that include two 7-minute halves of playing time, while rugby union consists of 15 players on each side which compete against each other in matches that include two 40-minute halves of playing time. In the U.S., Rugby Sevens is governed by USA Rugby. Meanwhile, USA Sevens is an annual rugby sevens tournament that is held every year in Las Vegas, Nev. The next one is scheduled for Feb. 13-15, 2015, with participating teams coming from 16 different countries, including the U.S. It's the 5th of 9 tournaments on the IRB Sevens World Series and since 2011 it has been broadcast live by NBC and NBC Sports. This event has been gaining popularity since it began with around 15,000 fans attending in 2004 and is currently the largest annual rugby competition in North America as it attracted nearly 70,000 fans in 2014 for the entire competition. In addition, the Collegiate Rugby Championship (CRC) tournament takes place around late May/early June each year with the last one held in Philadelphia, Pa. Since the first one was held in 2010, it has been broadcast live by NBC and NBC Sports. The next one will be called the Penn Mutual Collegiate Rugby Championship and will take place May 30-31, 2015. The International Olympic Committee announced in 2009 that rugby sevens would be an Olympic sport in 2016, which will provide a new opportunity for worldwide exposure of this version of rugby via live network broadcasting. In addition, there is still a Rugby World Cup Sevens event scheduled to be held every 4 years (e.g. the last one was held during June 2013 in Russia but in light of the 2016 Olympics, the International Rugby Board (IRB) clarified that the next one is planned for 2018). The U.S. national rugby team (the Eagles) for sevens is currently listed as 9th in the world out of 16 countries ranked by the IRB as of December 2014, compared to 14^{th} in the world as of December 2013.

With respect to rugby union, the last World Cup was held in New Zealand with the host country (All Blacks) beating France (Les Bleus) in the final match 8-7 on Oct. 23, 2011. Multi-platform coverage of the matches over a six week period were presented in the U.S. by Universal Sports and NBC Sports. During 2013, the U.S. and Canada participated for the first time in the Pacific Nations Cup from late May to late June. Other national teams who participated included Tonga, Japan and Fiji, who won the competition. During 2014, Samoa also participated and the 6 teams were divided into Asia/Pacific and Pacific Islands conferences, where Japan and Samoa respectively won the competition. Also, every 3 consecutive years following the World Cup, the Americas Rugby Championship is held during October. The participants in 2014 included the U.S., Canada, Uruguay, and Argentina, who won the competition. The New Zealand All Blacks recently played against the Eagles and won 74-6 in front of a sold out crowd of 61,500 fans at Soldier Field in Chicago, Ill. on Nov. 1, 2014. 1980 was the last time that the All Blacks played against the Eagles on U.S. soil. Meanwhile, it was estimated that almost half of the attendees were visitors from outside the U.S. This historic match was sponsored by AIG and broadcast live by NBC and NBC Sports. The next World Cup will be hosted by England with the final match scheduled for Oct. 31, 2015. Multi-platform coverage of the matches over a six week period will once again be presented in the U.S. by Universal Sports and NBC Sports. The current roster for the Eagles includes 55 players. 22 of them play professionally in foreign rugby union leagues (e.g. in Australia, England, France, Japan, Scotland and South Africa). Another 3 of them still play at the college level in the U.S., 2 of them are playing abroad in a non-professional league (Canada and Ireland) and 5 of them are not formally associated with another rugby union team. Meanwhile, 23 of them are actively playing at the non-professional men's club level in the U.S. For example, 7 of these players are members of the Seattle Saracens, formerly known as Old Puget Sound Beach RFC. This particular non-professional men's club team is independent and plays its own schedule separate from any league associated with the other high level men's clubs since June 2014 when it joined the Saracens Global Network (SGN). “Developing rugby union the USA has not been easy because of the sheer size of the country and also because of the huge popularity of the main professional sports, yet there remains huge potential”, said Nigel Wray, Chairman of SGN. According to SGN's web-site, “Saracens rugby club supports partner clubs within the global network through the provision of kit, coaching support and community programmes, and offers one young player from each club an opportunity to win a place in the Saracens Academy, a pathway into the professional game.” Seattle, Wash. is now joining the following international cities making up the SGN: VVA Moscow (Russia), Sao Paulo (Brazil), Abu Dhabi (United Arab Emirates), KL Kuala Lumpur, (Malaysia), Impala Nairobi (Kenya), Timisoara (Romania), and Toa (Tonga). The Chairman of SGN also added that “we have spent many months seeking a partner from coast to coast, and we are delighted to have agreed terms to form Seattle Saracens. The club has a dynamic committed Board and leadership group which embraces men's rugby, regularly producing US Eagles players . . . ” Meanwhile, the Eagles for rugby union are currently listed as 18th in the world out of 102 countries ranked by the IRB as of December 2014 (and 2013).

With respect to rugby union at the college level in the U.S., teams from the different divisional levels continue to compete for a national championship title every year. St. Mary's (CA) defeated Life University by a score of 21-6 in Stanford, Calif., in the final match for the Division I-A National Championship on May 10, 2014. This event was available live via USA Rugby TV, an online streaming service provided by USA Rugby. A Varsity Cup National Collegiate Rugby Championship was separately launched in 2013 with 8 highly ranked teams from Division I-(A or AA) participating. Meanwhile, the number of teams competing for the Varsity Cup increased from 8 to 12 in 2014. Brigham Young University defeated the University of California, Berkeley by a score of 43-33 in the final championship match, which took place in Sandy, Utah on May 3, 2014. This event was broadcast live on NBC Sports Network. In 2015, the final Penn Mutual Varsity Cup championship match will be held in Sandy, Utah, and broadcast live on NBC Sports Network again. The teams who will compete on May 2, 2015 for the Penn Mutual Varsity Cup include:

U.S. Air Force Academy (USAF), CO

Brigham Young (BYU), UT

University of California, Berkeley (UC Berkeley), Calif.

Clemson, S.C.

Dartmouth, NH

U.S. Naval Academy (Navy), MD

University of California, Los Angeles (UCLA), Calif.

Notre Dame, Ind.

Oklahoma, Okla.

Utah, UT

University of Texas, Austin (U. of TX, Austin), Tex.

Central Washington University (CWU), WA

According to USA Rugby, the aforementioned Varsity Cup teams are currently listed under either Division I-A or I-AA, except for U. of TX, Austin.

FIG. 1 includes current details of all 37 Division 1-A and 127 Division 1-AA college teams. There are also currently 130 Division II college and 234 NSCRO teams. In July 2014, USA Rugby announced the names of 47 Collegiate All-Americans and 45 Honorable Mention All-Americans. A very high percentage of them are playing at either the Division 1-A or Division 1-AA level.

Finally, with respect to rugby union at the non-professional men's club level in the U.S., the Pacific Rugby Premiership (PRP) had for each team a 12 game regular schedule/season, which took place in the spring of 2014. The 7 teams or rugby football clubs (RFC's) who currently compete in this league include:

Old Mission Beach Athletic Club (OMBAC), CA

Belmont Shore, Calif.

Olympic Club, CA

San Francisco Golden Gate, CA

Santa Monica Dolphins, CA

Denver Barbarians, CO

Glendale Raptors, CO

The final championship match was held on May 17, 2014 in Glendale, Colo. and was won by San Francisco Golden Gate 39-38 against Glendale Raptors. This event did not have live network broadcasting (other than online streaming via a live webcast).

Meanwhile, the American Rugby Premiership (ARP) had for each team a 4 game regular schedule/season, which took place from September to October 2014. Such schedule/season continues again with an additional 4 games for each team from April to May 2015. The 5 teams or rugby football clubs (RFC's) who currently compete in this league include:

Boston RFC, MA

Boston Irish Wolfhounds, MA

Life University (Running Eagles), GA

New York Athletic Club (NYAC), NY

Old Blue RFC, NY

A final championship match date, including details about potential broadcasting, has yet to be announced. Meanwhile, there is also a Northeast Challenge Series whereby each of the ARP teams, except for Life University, are playing at least 2 matches each against certain Division I men's club teams from the Atlantic North division in both a fall 2014 and spring 2015 schedule. In addition, there is an American Challenge Series whereby each of the ARP teams would be expected to play at least 2 matches each against certain Division I men's club teams from the Eastern part of the U.S. in both a fall 2014 and spring 2015 schedule. However, a full schedule/season for either the fall 2014 or spring 2015 has yet to be announced.

Finally, this year, the top teams from Division I participated in a single elimination competition that ended on May 31, 2014 with a final championship match. Such match was held in Madison, Wis. and was won by Life University 39-7 against New Orleans Rugby. This event did not have live network broadcasting (other than online streaming via a live webcast). Meanwhile, it should be noted that Life University has a unique status as the only college team to participate in the Division I-A collegiate league as well as the Division I men's club and ARP leagues.

FIG. 2 includes current details of all 35 Division I men's club teams across the Atlantic North, Mid-Atlantic, Midwest, Red River and Pacific South geographical regions.

There are also currently 105 Division II and 176 Division III men's club teams across the aforementioned geographical regions, including a Southern one. The top teams from Division II and III respectively also competed for a national championship title in a single elimination competition that also ended on May 31, 2014.

Currently USA Rugby as a legal entity falls under Section 501(c)(3) of the U.S. tax code, as it fosters national or international amateur sports competition, which essentially exempts it from taxation, as it is deemed to be “organized and operated exclusively for exempt purposes . . . , and none of its earnings may inure to any private shareholder or individual.”

It's estimated that USA Rugby in total generated revenue of approximately $12.2 million for the 2013 season, compared to approximately $10.2 million for the 2012 season.

The sources of such revenue are as follows:

(1) Membership dues

(2) High performance grants

(3) Merchandising and licensing

(4) Corporate sponsorship

(5) Event related income

(6) Donations

On the cost side, USA Rugby has the following expenses:

(1) National teams (men and women)

(2) High performance expenses

(3) Membership related costs

(4) Rugby development

(5) Event related costs

(6) Sales/marketing

(7) General & administrative

With respect to legal matters, the most serious matter for rugby union is the ongoing process by the IRB to ensure it is doing everything possible and within reason to enact rules that are designed to prevent a scrum from collapsing as such an incident can lead to serious spinal injuries for a player, especially in the hooker position. In general, each team is currently allowed at the start of the match to have up to a 23 player squad, which includes 15 starting players and 8 nominated substitutions/replacements. It is necessary not only to have suitably trained and experienced players in the front row (i.e., the 2 props and 1 hooker) at the start of the match, but also during the match if one of them gets injured and needs to be replaced. In recent years the IRB has updated or clarifed rules about proper replacements for the front row. For example, in November 2012, it clarified that if a team uses up its supply of suitably trained and experienced players in the front row, the referee must order an uncontested scrum (instead of the typical contested scrum) and the player whose departure caused the uncontested scrum can not be replaced. Also, as an additional effort to reduce collapses in contested scrums, the IRB in May 2013 introduced the start of a global trial of the “crouch, bind, set” scrum engagement sequence. It is designed to improve player welfare by reducing the impact on engagement. As a result of this revision, props will need to bind onto their respective opponent's back jersey using their outside arm after the referee has called out “bind” in the middle of the sequence. Thereafter, a brief pause will follow as the front rows will maintain the bind until the referee calls out “set”. At such point, the two competing “packs” (i.e. front rows actively supported by their other forwards) will engage against each other (in a contested scrum) to gain ground and possession of the ball.

### Point Scoring in Rugby Union

The main aim of each team is to advance the ball forward toward the opposing side's try zone to score points via a try or drop kick. In doing so, passing the ball to your teammate behind you or to the side, as a lateral or pitch, is allowed but passing the ball forward to your teammate is not. When scoring a try, the ball carrier must physically place the ball down on the ground in such try zone to be awarded 5 points. Thereafter, the ball can be taken out directly from the try zone (in a straight line) and placed on the ground (without someone holding it) for an unopposed conversion field goal attempt. To be awarded the 2 conversion points, the ball must be kicked high enough through the uprights or middle of the field goal posts. Also, it is possible to be awarded 3 points in this manner as the result of a penalty kick. In addition, during play as a ball carrier it is possible to drop the ball to the ground and simultaneously kick (i.e. drop kick) the ball and be awarded 3 points, however once again it must be kicked high enough through the uprights or middle of the field goal posts.

### Player Positions and Team Formation of Rugby Union

As with other team sports, rugby teams often organize into specific formations at the start of play. FIG. 3 illustrates one formation that a full rugby team of 15 players in accordance with “rugby union” rules typically develops just before the start of play (e.g., scrum). The scrum is an assemblage used to restart play and consists of the 8 forwards (i.e., positions (1)-(3) in the front row, (4)-(7) in the second row and (8) in the back of the scrum). The 7 backs or positions (9)-(15) are typically lightly built and fast. They play behind the 8 forwards, who are typically big and strong due to the demands of competing in the scrum. All players need to (i) have endurance skills as they are moving up and down on the field at all times, except in the case of an injury, and (ii) be well rounded enough as an athlete to handle both offensive and defensive plays, including both passing/kicking and tackling/punting. For example, a change in possession during play automatically changes a player's position from offensive to defensive and vice versa. Also, with respect to a “line-out,” technically speaking any player on a team can be a part of it (though it is generally composed of forwards). In a typical line-out situation, a “hooker” from the sideline is throwing the ball in over the top of the line-out and is aiming for the “locks” being lifted into the air by the “props.” The overall aim of each team is to advance the ball forward toward the opposing side's try zone to score points via a try or drop kick.

These positions, and others, are described below in a brief overview of player positions under rugby union rules.

Forwards:
(1) Loosehead prop; this is a front row position and is considered very specialized. The job of this prop is to “prop up” the hooker in the scrum from the left side. His head will be on the outside of the scrum when it engages. The main role of the prop is to provide stability in the scrum and support the hooker in quickly winning the ball. They also have to absorb the opposition's force and try to move the scrum forward. Thus, the physique for such a position typically includes short necks, broad shoulders and powerful legs.
(2) Hooker; this is a front row position and is considered very specialized. When the scrum engages, his head will be positioned between the two props. After the ball is put into the scrum by the scrum-half, the main role of the hooker is to use his feet to “hook” the ball back and win possession for his team. The physique for such a position typically includes a short back and long arms, which aid in binding to props. Hookers generally throw the ball into the line-out and are more mobile than the props so they may run with the ball during open play.
(3) Tighthead prop; this is a front row position and is considered very specialized. The job of this prop is to “prop up” the hooker in the scrum from the right side. His head will be positioned between the opposition (i) loosehead prop and (ii) hooker when it engages. The main role of the prop is to provide stability in the scrum and support the hooker in quickly winning the ball. They also have to absorb the opposition's force and try to move the scrum forward. Thus, the physique for such a position typically includes short necks, broad shoulders and powerful legs.
(4) Number-4 lock; this is a second row position. During the scrum, they push against the front row and provide much of the power. The two locks bind together tightly and slide their heads between the back sides of the appropriate prop and the hooker. They are the primary targets when the ball is thrown in at line-outs so they must have good catching ability. Also, the physique for such a position typically includes being the tallest players on the team.
(5) Number-5 lock; this is a second row position. During the scrum, they push against the front row and provide much of the power. The two locks bind together tightly and slide their heads between the back sides of the appropriate prop and the hooker. They are the primary targets when the ball is thrown in at line-outs so they must have good catching ability. Also, the physique for such a position typically includes being the tallest players on the team.
(6) Blindside-flanker; this is a position that loosely binds to the scrum alongside the appropriate lock and plays an important role in keeping the props tight by pushing at an angle. During the scrum, the blindside-flanker covers the side nearest to the side-line i.e. blindside. Flankers have a high work rate so they need to be physically fit and good at reading the opposing side's attacking plays. Thus, their main role is to tackle the opposition and try to steal the ball. For example, the blindside-flanker has the task of stopping any attempt by the opposing number-8 from running with the ball around a scrum's blindside.
(7) Openside-flanker; this is a position that loosely binds to the scrum alongside the appropriate lock and plays an important role in keeping the props tight by pushing at an angle. During the scrum, the openside-flanker covers the side with the greatest open area i.e. openside. Flankers have a high work rate so they need to be physically fit and good at reading the opposing side's attacking plays. Thus, their main role is to tackle the opposition and try to steal the ball. For example, the openside-flanker is often used to charge the opposing fly-half in order to put pressure on him and force him to rush in making a decision about kicking or passing the ball.
(8) Number-8; this is the furthest back position in the scrum as he binds between the locks and provides extra weight at the push. His main role is to get control of the ball and provide it cleanly to the backs (from the back of the scrum) by interacting with the scrum-half. They can either pick the ball up and run with it or flick it to the scrum-half. Also, they can be a target when the ball is thrown in toward the back of line-outs so they should have good catching ability. Physically, they are strong so this forward as a ball carrier is expected to push past the opposition's defensive line. Thus, on the opposing side, they'd be expected to stop the attacking side's number-8 in breaking past the defensive line.

Backs:
(9) Scrum-half; he is the link between the forwards and backs. They either receive the ball from the line-out or remove the ball from the back of the scrum (and usually pass it to the fly-half). They also insert the ball at the start of a scrum and can act as a fourth loose forward. They make many tactical decisions on the field in addition to the fly-half. They must be effective communicators since they are directing the forwards around with the aim of getting the ball from them and passing it to the backs. In terms of other skills, they should be excellent at passing, good in tactical kicking and deceptive as a ball carrier.
(10) Fly-half; he is the leader of the backs and a key decision maker. He is typically the first one in the back line to receive the ball from the scrum-half. Thus, he must be decisive (and an effective communicator with the other backs) in terms of what actions to take on attacking plays. They must have good passing and kicking skills while running. Thus, they are often times the team's goal kickers.
(11) Left-wing; he is a back outside of the back line on the left. His main role is to finish off offensive running plays and score tries. They are usually the fastest players on the team and should be elusive runners. They will drop back on opposition kicks to support the fullback on either defensive playing or counter-attacking.
(12) Inside-centre; he is a back that stands close to the fly-half and is typically the first ball receiver on attacking plays from the back line. His main role is to run good lines and be agile enough to side step and swerve when running with the ball and avoiding defenders. In that regard, they also need to (i) have good ball passing skills to the players outside them (e.g. outside-centre, wing, etc.) and (ii) be able to offload the ball when being tackled. When playing defense, they need to be good at reading the opposing side's play and reacting as aggressive tacklers by knocking their opponent down to the ground and trying to gain possession of the ball.
(13) Outside-centre; he is a back that stands outside the inside-centre and is typically the second first ball receiver on attacking plays from the back line. His main role is to run good lines and be agile enough to side step and swerve when running with the ball and avoiding defenders. In that regard, they also need to (i) have good ball passing skills to the players outside them (e.g. wing, fullback, etc.) and (ii) be able to offload the ball when being tackled. The outside-centre is typically faster than the inside-centre and has more room to move when running with the ball. When playing defense, they need to be good at reading the opposing side's play and reacting as aggressive tacklers by knocking their opponent down to the ground and trying to gain possession of the ball.
(14) Right-wing; he is a back outside of the back line on the right. His main role is to finish off offensive running plays and score tries. They are usually the fastest players on the team and should be elusive runners. They will drop back on opposition kicks to support the fullback on either defensive playing or counter-attacking.
(15) Fullback; he is a back that is typically positioned several meters behind the back line. It's his job to field any deep opposition kicks and to be the last line of defense if an opponent breaks through the back line. Thus, they must have good catching ability under a high kick, the ability to punt the ball a long distance with accuracy as well as the speed and skill to join in the back line when attacking and counter-attacking. They are often times the team's goal kickers. If the opposing side makes a misdirected kick and the fullback catches the ball, then he has the most potential for leading a counter-attack assuming he has enough space on the field and support from the other backs. When playing defense, they need to be good at reading the opposing side's offensive plays and work with the other backs in closing any holes in the defensive line.

### Brief History of Professional American Football

American football originated in the U.S. from association football and rugby football, both of which originated from Britain, in the mid-19^{th} century. During such time, association football generally involved kicking a football at a goal while rugby football generally involved running over a line with it. While certain high level universities such as Yale, Rutgers, Princeton and Columbia preferred association football (or “soccer” as it's known in the U.S. today), Harvard preferred the rougher alternative that was closer to rugby football and it was called the “Boston Game” with typically 10 to 15 players per side. Based on the “Boston Game” rules, the first games to take place in the US were between Harvard and McGill, visiting from Canada, with Harvard winning 3 times on May 14, 1874. However, the first inter-collegiate US game was played between Harvard and Tufts on Jun. 4, 1875 with Tufts winning 1-0. In 1876, Harvard convinced Princeton and Columbia to form the Intercollegiate Football Association (IFA) essentially based on rugby football (or rugby union rules at the time). Walter Camp, while captain of Yale's team, succeeded in instituting several major divergences from rugby football in 1880 and is considered to be the “Father of American Football”. His proposed changes, which were accepted at a rules convention, made American football uniquely different from rugby football in the following ways:
(1) While a rugby football scrum starts with a contest for possession or contested scrum or “scrummage”, Camp's new rule replaced it with a line of “scrimmage” where one team had uncontested possession from the start and would have 3 downs or tackles to advance the ball 5 yards—this divergence means that each team is either on offense or defense on each play and was later amended to 4 downs to advance the ball 10 yards in 1906;
(2) While the standard number of rugby football players on the field at any time (playing either offense or defense) is 15, Camp's new rule modified this to 11 players on each side playing either offense or defense—this divergence also led him to introduce the standard offensive set up of players, which included a 7 man offense line and 4 man backfield consisting of a quarterback, two half backs and a full back. Such set up also led him to introduce the snap back of the football from the center to the quarterback.
(3) While a rugby football scrum is awarded 5 meters from the goal line to the attacking side for tackling an opposing ball carrier within his own try/end zone, Camp's new rule replaced it with awarding 2 points (or “safety) to the attacking side, followed by a free kick to the attacking side (i.e. by the opposing side from its own 20 yard line) to start the next play.

Other changes in American football from rugby football emerged in areas such as the use of protective equipment. Players started using shoulder and other pads in the last decade of the 19^{th} century as well as the helmet (close to its modern form) by 1915. These developments have led to American footballers tackling with their heads, knocking opponents to the ground and using more force on each play in general (when compared to rugby footballers) especially since a tackle stops play. Meanwhile, tackling in rugby football forbids hitting above the plane of shoulders and requires wrapping your arms around the ball carrier with play continuing immediately thereafter as he must release the ball upon being tackled. Also, players in American football can block opponents on the field who don't have the ball. Meanwhile, rugby football does not allow for blocking and doing so would result in a penalty being called for obstruction. During the presidency of Theodore Roosevelt, the Intercollegiate Athletic Association of the United States (IAAUS) was established in 1906 not only to reform American football with more uniform rules, but also to protect students in general from the dangerous and exploitive athletic practices of the time. Hence the IAAUS became not only the original rule making body of American football at the college level, but also would go on to sponsor championships in other sports. Already in 1906, the rules committee legalized the forward pass and the first one was thrown by Bradbury Robinson on September 5^{th} that year playing for Saint Louis University. Thereafter the ball's shape began to evolve into a longer and slimmer version as the forward pass became a more popular part of the game. Also, time of play was reduced from 70 minutes to 60 minutes, which are divided into 4 quarters of 15 minutes. The IAAUS had its name changed to NCAA (or National Collegiate Athletic Association) in 1910 and still retains governing authority over American football rules at the college level.

The newly evolved version of American football became the dominant one at the college level during the first half of the 20^{th} century. Also, popularity for it grew out of “bowl games” which are a number of post-season college games that drew national attention from fierce rivalries between teams. The first bowl game was held in 1902 between Michigan (East) and Stanford (West) with the final score being 49-0, respectively.

While the first professional game dates back to 1892 between the Allegheny Athletic Association and the Pittsburgh Athletic Club, the American Professional Football Association was not formed until 1920 in Canton, Ohio. The league started with 14 teams and two years later its name would change to the National Football League (NFL).

During the first half of the 20^{th} century, baseball was not only America's pastime but also more popular than American football as a professional sport. However, at the professional level, an inflection point was the 1958 NFL Championship Game, which has been referred to as the “Greatest Game Ever Played.” This game was carried live on NBC television network to a national audience who was able to watch a thrilling game between the Baltimore Colts and NY Giants at Yankee Stadium in NYC in which the Colts beat the Giants 23-17 in overtime.

In 1959, the American Football League (AFL) was established as a rival league to the NFL. However, with the exception of New York and Los Angeles, the AFL's other 6 teams were not based in local markets directly competing with the NFL. The AFL's season began in 1960 and 6 years later succeeded in a partial merger with the NFL. Such merger resulted in a common draft and season ending championship game, which was initially called the “AFL-NFL World Championship Game” and ultimately renamed “Super Bowl” from January 1969 when the NY Jets beat the Baltimore Colts 16-7. The complete merger of the AFL into the NFL took place in 1970 with a total of 26 teams, while today it stands at 32 teams.

Since 1965 or just before the Super Bowl era began, American football has overtaken baseball as the most popular professional sport in the U.S. among fans, according to the Harris Poll.

A significant change also took place in 1993 with the NFL introducing a hard salary cap on player salaries at the team level as well as revenue sharing between its clubs. This complex labor agreement with its player's union was designed to create more parity among its 32 teams and prevents the wealthiest teams from amassing the best players, thus providing an opportunity for teams even from smaller cities to compete for the Super Bowl.

### Current Status and Trends: Professional American Football

American football today is the most popular professional sports in the U.S. and represents a major share of American broadcasting during its fall/winter season, including the playoffs and the Super Bowl. As a result, the NFL is a multi-billion dollar industry and is the most lucrative sports league in the world. There are 32 NFL team/club organizations that cover 23 states. According to Forbes magazine in Jul. 2014, 30 of these 32 teams are in the top 50 for wealthiest sports franchises in the world. Such NFL teams have a total value of $45.7 billion and average value of $1.428 billion, per team. FIG. 4 presents the current market value, 2013 revenue and 2013 operating income of each NFL team according to Forbes magazine.

Currently the NFL as a legal entity and professional football league falls under Section 501(c)(6) of the U.S. tax code, as it's a business league, which essentially exempts it from taxation. It's deemed “an organization whose primary purpose is to further the industry or profession it represents” and it's “not organized for profit and no part of the net earnings of which inures to the benefit of any private shareholder or individual.” According to Brian McCarthy, the NFL's spoke person:
“The NFL League Office is a not-for-profit organization. The NFL League Office receives funding from the 32 member clubs to cover its non-revenue overhead activities such as office rent, League Office salaries and game officiating. In addition, the NFL League Office collects revenues on behalf of the 32 member clubs and distributes those revenues to the clubs. All national revenues (e.g. broadcast TV payments) collected and paid to the member clubs, as well as local revenues earned individually by the clubs, are subject to tax at the club level.”

The NFL also collects $6 million in annual dues from each team and these dues are used to fund interest-free loans to teams in need of building new stadiums. In addition, NFL Ventures, which is owned by the 32 teams, is subject to taxation and generates revenue from sources such as NFL Network, national sponsorship deals and merchandise sales. It's estimated that the NFL as a whole including its 32 teams generated revenue of approximately $9.6 billion for the 2013 season, compared to approximately $9.5 billion for the 2012 season. The sources of such revenue are as follows:

(1) Television & radio broadcasting rights

(2) Merchandising and licensing

(3) Stadium ticket sales

(4) Private box seats

(5) Local marketing, sponsorship, and pro shops

(6) Local media and stadium parking/concessions

The NFL negotiates television & radio broadcasting rights at the national level on behalf of the clubs with major networks such as Fox, CBS, NBC and ESPN and initially receives this revenue, which is subsequently redistributed to the clubs. Also, in order to protect its brand, the NFL maintains control to negotiate and license with vendors in producing official NFL merchandise. In terms of stadium tickets sales, each club retains 60% of stadium tickets sales for home games, with the remaining 40% going to the NFL as a pool of funds, which is subsequently redistributed to the clubs, as compensation for playing away games. Meanwhile, the 32 clubs each keep 100% of revenue related to (4)-(6) above.

In terms of player compensation based on the 2011 collective bargaining agreement, which will be valid until 2021, the total salary pool includes: (a) 55% of broadcasting revenue (i.e. (1) above), (b) 45% of merchandising and licensing revenue (i.e. (2) above) and (c) 40% of local team revenues (i.e. (3)-(6) above). Overall, the players must receive at least 47% of all revenue in salary over the 10 year term agreement. On the cost side, each team/club has the following expenses:

(1) Player salaries

(2) Game day expenses

(3) Team related expenses

(4) Sales/marketing

(5) General & administrative

Under NFL rules, each team/club organization is only allowed to have a 53-man active roster to make up their offense, defense and special teams with no more than 11 players on the field at any time. Typically, the kicker and punter are the only 2 players to have a role that is limited to just special teams while the other players on special teams are coming from either the offense or defense. In other words, after excluding the kicker and punter, in terms of depth of players for the 1^{st} string offense and defense (i.e., two teams of 11, for a total of 22), they typically have more than twice they need (e.g., a total of 51) to start a game. The reason being is that the team needs 2^{nd} and 3^{rd} string back up players in case 1^{st} string players get hurt during the game. Also, each team is actually allowed to have up to 90 players on its full roster after also including the league standard eight-man practice squad and injury lists (i.e. physically unable to perform or injury reserve lists). Meanwhile, in terms of limitations, the practice squad can only consist of players who appeared on the active roster for no more than one season and for no more than nine games. Also, the eight players selected for the squad are permitted to practice with the active roster and typically represent younger players who have room for further development.

In terms of relevant legal matters, the Supreme Court in May 2010 rejected the NFL's request for broad antitrust law protection with respect to American Needle v. National Football League, No. 08-661, saying that it must be considered 32 separate teams and not one entity when selling branded items like jerseys and caps. Justice John Paul Stevens wrote for a unanimous court “the mere fact that the teams operate jointly in some sense,” he wrote, “does not mean they are immune.” He also wrote “Each of the teams is a substantial, independently owned and independently managed business” and “the teams compete with one another, not only on the playing field, but to attract fans, for gate receipts and for contracts with managerial and playing personnel.” Justice Stevens continued “although NFL teams have common interests such as promoting the NFL brand, they are still separate, profit-maximizing entities, and their interests in licensing team trademarks are not necessarily aligned”. He also write “The teams compete in the market for intellectual property” and “To a firm making hats, the Saints and the Colts are two potentially competing suppliers of valuable trademarks. When each NFL team licenses its intellectual property, it is not pursuing the “common interests of the whole” league but is instead pursuing interests of each “corporation itself,” . . . teams are acting as “separate economic actors pursuing separate economic interests,” and each team therefore is a potential “independent cente[r] of decisionmaking.”

In August 2013, the NFL agreed to settle a concussion lawsuit by a group of its former players or retirees with debilitating injuries for $765 million while admitting no fault. However some of these players may opt out of the settlement and continue pursuing their cases, which make claims against the league for negligence and fraud. In brief, the proposed settlement (which was delayed for preliminary approval on Jan. 14, 2014 by a federal judge who asked both parties to back up their assertions that the agreement negotiated is appropriate), would include: $675 million for players or families of players who sustained cognitive injury regardless of whether it was related to football; up to $75 million for baseline medical exams; $10 million for a research fund; up to $3 million for players with Parkinson's or Alzheimer's; as much as $4 million for the estates or families of players who committed suicide and were found to have chronic traumatic encephalopathy; and up to $5 million for those with amyotrophic lateral sclerosis. As of July 2014, this proposed settlement received preliminary approval but it does not cover current players. However, the NFL has changed its rules in an attempt to make the game safer and modified its medical protocols for concussions as there is mounting scientific evidence in recent years linking head trauma sustained on the field to long-term cognitive damage.

### Point Scoring in American Football

The main aim of each team is to advance the ball forward toward the opposing side's end zone to score points via a touchdown or field goal. When scoring a touchdown, the ball carrier must cross over anywhere in the end zone to be awarded 6 points. Thereafter, the ball is taken out and placed on the line of scrimmage, which is 2 yards from the end zone, as the offensive and defensive sides (or special teams) line up against each other for an opposed conversion field goal attempt that includes not only a kicker, but also his place holder for the ball, which is snapped back to him by the center. To be awarded 1 conversion point in this case, the ball must be kicked high enough through the uprights or middle of the field goal posts. Also, it is possible to be awarded 3 points in this manner as the result of a field goal attempt when the offense is deep enough in the opposing side's territory and decides to exclude other offensive options.

### Player Positions and Team Formation of American Football

As with other team sports, American football teams often organize into specific formations at the start of play. FIG. 5 illustrates formations that two opposing American football teams with 11 players on each side might use at the start of play. The offense side starts with possession of the ball and its aim is to move the ball toward the opposing side's end zone to score points via a touchdown or field goal. The two major parts of the offense are the 5 offensive linemen at the line of scrimmage who typically act as blockers for the 6 backs/receivers who are eligible ball carriers. Meanwhile, the aim of the defense is to stop the offense and gain possession of the ball. The three major parts of the defense are the 4 defensive linemen at the line of scrimmage, 3 linebackers just behind them and 4 defensive backs, who line up further back in the “secondary”.

Below includes a brief description of each player position for American football under NFL rules:

Offense:

(C) Center; he is the player at the center of the offensive line and starts play by a direct snap hand-off or thrown snap pass to the quarterback, who is lined up directly behind him. After play starts, his main role is to block against the defensive players on the opposing side.

(OG) Offensive guard; as there are 2 OG's, he lines up directly on either side of the center. After play starts, his main role is to block against the defensive players on the opposing side. However, on some plays, instead of just blocking straight ahead, he may come out of his position on the offensive line to lead block for a ball carrier on either inside runs (traps), outside runs (sweeps) or passing plays (screens).

(OT) Offensive tackle; as there are 2 OT's, he lines up directly on either side of the respective OG. After play starts, his main role is to block against the defensive players on the opposing side. However, like OG's on some running plays, instead of just blocking straight ahead, he may come out of his position on the offensive line to lead block for a ball carrier. Also, the OT on the left side is expected to protect a right handed quarterback from being hit from behind or the left side (known as the quarterback's “blind side”)—a critical role requiring an additional skill.

(Q) Quarterback; he is the leader of the offense and communicates the next offensive play to be run with his teammates in the huddle before they set up in a starting formation against the opposing defense. At the line of scrimmage, he makes audible calls to start play and will immediately receive the ball from the center from one of three positions: (1) “under center” where he is positioned directly behind the center and receives it via a direct snap hand-off; (2) “in the shotgun” where he is standing some distance behind the center and receives it via a thrown snap pass; or (3) “pistol” where he is lined up in between what is normally “under center” or “in the shotgun”. The quarterback has three basic choices to move the ball forward such as (1) running with it himself, (2) handing/pitching it off to an eligible ball carrier such as a fullback or halfback or (3) throwing a forward pass to an eligible ball receiver over the line of scrimmage.

(FB) Fullback; he is a running back (RB) who typically lines up directly behind the quarterback and offensive line at the start of play. Thus, they are in a position to receive the ball from the quarterback to carry out a rushing play. Also, they are typically larger and stronger than halfbacks. Thus, they can act as blockers on rushing plays where the halfback receives the ball from the quarterback. In addition, they may be expected to catch passes from the quarterback as eligible receivers.

(HB) Halfback; he is a running back (RB) who typically lines up directly behind the fullback and quarterback at the start of play. Thus, they are in a position to receive the ball from the quarterback to carry out a rushing play and are typically the primary ball carrier on such a play. Also, they may be expected to catch passes from the quarterback as eligible receivers.

(TE) Tight end; he is considered a hybrid player or something between an offensive lineman and wide receiver. They play on either side of (and close to) the offensive tackles at the line of scrimmage. Thus, on running plays, they are expected to assist the offensive tackles as blockers. However, on passing plays, they are eligible receivers who are expected to catch passes and run with the ball. They could also line up behind the line of scrimmage and be positioned to act more like a running back.

(WR) Wide receiver; he is a specialist in catching passes from the quarterback. His main role is to run pass routes over the line of scrimmage or down field in order to get open for a pass. As the offense has 2 WR's, one of them typically needs to be lined up at the line of scrimmage on the left or right side of the offensive line at the start of play to meet the 7 player requirement. This “split end” may be called up on to block. Meanwhile, the other WR would be free to be positioned wider near the sidelines at the start of play.

Defense:

(DT) Defensive tackle; as there are 2 DT's, they line up alongside each other at the center of the defensive line. However, one of them may line up as a nose tackle i.e. facing the ball and directly across from the offensive side's center. Their main role is either to stop running plays coming from the middle of the line of scrimmage or to get past the offensive linemen, who are blocking them, and try to rush and tackle the opposing side's quarterback before he passes off the ball.

(DE) Defensive end; as there are 2 DE's, they line up directly on either side of the respective DT's. Their main role is either to stop running plays coming from the outer edges of the line of scrimmage or to get past the offensive linemen, who are blocking them, and try to rush and tackle the opposing side's quarterback before he passes off the ball. Out of the 2 DE's, the one who is faster is typically lined up on the right side so he is better positioned to rush and tackle a right handed quarterback from his blind side.

(MLB) Middle linebacker; he is often referred to as the “quarterback of the defense” who typically communicates the next defensive play to be run with his teammates in the huddle before they set up in a starting formation against the opposing offense. They line up just behind the center of the defensive line and must be ready to react to diverse situations. Their main role is either to stop running plays that make it past the defensive line, cover passing plays over the middle and rushing/tackling the opposing side's quarterback when a defensive “blitz” play is run.

(OLB) Outside linebacker; as there are 2 OLB's, they line up on either side of the MLB. Their main role is either to stop running plays coming from the outer edges of the line of scrimmage or to cover the opposing side's tight end (TE) or running backs on pass plays. The strong-side OLB lines up on the same side as the TE in order to cover him, while the weak-side OLB lines up on the other side so he's able to rush the opposing side's quarterback on a defensive “blitz” play.

(CB) Cornerback; he is a defensive back (DB) and there are 2 CB's, who line up on either side of the line of scrimmage. Their main role is to cover the opposing side's wide receivers on pass plays so they need to be fast. On such pass plays, they can either swat the ball away to prevent a successful completion or catch the pass themselves and run the ball back. On running plays, they are expected to contain the opposing side's runner via tackling him, pushing him out of bounds by the sidelines, or forcing him to the middle of the field to be tackled by another teammate.

(SS) Strong safety; he is a defensive back (DB) and there are 2 safeties, who line up the furthest back from the line of scrimmage. Their main role is to help CB's with deep-pass coverage. They are the last line of defense so they must be fast and able to tackle the opposing side's runner. On such pass plays, they can either swat the ball away to prevent a successful completion or catch the pass themselves and run the ball back. The SS is typically the larger and stronger of the two safeties so he lines up closer to the line of scrimmage to provide extra protection against running plays.

(FS) Free safety; he is a defensive back (DB) and there are 2 safeties, who line up the furthest back from the line of scrimmage. Their main role is to help CB's with deep-pass coverage. They are the last line of defense so they must be fast and able to tackle the opposing side's runner. On such pass plays, they can either swat the ball away to prevent a successful completion or catch the pass themselves and run the ball back. The FS is typically the smaller and faster of the two safeties so he would be positioned in the very back of the defense to provide extra protection against the deep pass plays.

Aside from the standard offensive and defensive positions above, there are also 11 players represented on each side for special teams during kick offs and punts (as well as field goal attempts). In that regard, a key position is that of the Kicker (K) or Punter (P). The kicker's role is typically limited to special teams on kick offs and field goal attempts, including an extra point conversion after a touchdown. On kick offs, he must be prepared to kick the ball off the ground downfield toward his opponent's goal line with sufficient distance and accuracy. On field goal attempts, he must be prepared to kick the ball off the ground and high enough through the uprights or middle of the field goal posts from either short or long range. The punter's role is typically limited to special teams on punts. In such case, which is typically on 4^{th} down and as a defensive move, the punter must receive the ball being snapped back to him by his center and be prepared to drop the ball from his hands and kick it in the air downfield toward his opponent's goal line with sufficient distance and accuracy. Also, in that regard, another vital position on the other side is that of the Kick Returner or Punt Returner (both of which are abbreviated “KR” below). His main role is to catch highly kicked balls (on either kick offs or punts) and to run the ball back as far as possible to the opposing side's end zone. They are typically the fastest players on the team. Thus, the team may use the same player to be the kick returner and punt returner. Also, the KR's main position on the team may be from the offense as a (FB), (HB) or (WR) or from the defense as a (FS), (SS) or (CB).

### SUMMARY

On the one hand, there exist 32 team/club organizations in the NFL who are currently focused on and competing in the professional American football market. At the same time, they have an untapped talent pool for professional rugby players in the U.S. For example, their 2nd string and 3rd string players in particular are not only underutilized during the regular fall season, but also remain idle during the spring off season and thus are currently missing out in reaching their full earning potential in a double or second career as professional rugby players. These NFL teams are also under utilizing their stadiums, which could be hosting grounds for home rugby games in the spring season. Doing so would yield higher revenue in all categories (e.g. ticket sales, broadcasting revenue, corporate sponsorship and merchandising/licensing deals, among other things).

On the other hand, there exist 2 non-professional rugby union leagues with Division I Club players from a total of 12 different teams who (i) are divided up into either the Pacific Rugby Premiership (PRP), a West pool, or the American Rugby Premiership (ARP), an East pool, and (ii) compete annually in the spring season and fall/spring season, respectively.

If one or more NFL and/or other professional (including semi-professional) American football teams/clubs created their own rugby teams (each with at least 15 starting players), which could first include a starting team of experienced rugby players and thereafter include a mix of players from its existing football roster as well as other rugby recruits, these new professional rugby union teams could join either the East (ARP) or West (PRP) pool as appropriate and also compete annually toward a final championship match between the winners of each pool. In doing so, the American football teams/clubs would be able to increase or maximize use of their available assets (e.g. player capacity, stadium capacity, branding power, etc.) by expanding and integrating their own rugby teams into the 2 highest level non-professional rugby union leagues in the U.S. The American football teams may then be able to professionalize the rugby teams and/or league and may be able to profit from the rugby teams and/or league over time. Another alternative would be to create a new layer of professional rugby teams on top of the ARP and PRP. Either way, the end result would be the same as both are dependent on the expansion and integration by the American football teams (NFL) directly (or indirectly through a separate legal entity) at some point.

The figures discussed below in connection with the detailed description, including FIGS. 6-9 originated by the inventor, illustrate examples of a way for an American football team (e.g., an NFL team) to build and improve a professional or non-professional rugby union team. FIGS. 6 and 9 specifically illustrate examples of initial and later phases, respectively, that may form a part of a process for building and improving, respectively, a rugby union team. In that regard, FIG. 7 demonstrates examples of resources that each NFL team may be able to use to build its own rugby union team, including local talent from men's clubs and colleges within the geographic region of the NFL team. Also, FIG. 8 shows a modified rugby union team formation, based on a combination of experienced rugby and NFL players, that a rugby union team created by an American football team/club organization may advantageously use in some implementations, though other team formations are possible.

### BRIEF DESCRIPTION OF FIGURES

FIG. 1 is a current list of Division 1-A and 1-AA college rugby teams in the U.S.

FIG. 2 is a current list of Division I men's club teams in the U.S.

FIG. 3 shows a standard Rugby union team formation.

FIG. 4 is a current list of NFL teams in the U.S. including their respective market values and operating results.

FIG. 5 shows a standard American football team formation.

FIG. 6 originated by the inventor, shows initial phases for NFL team to build its own rugby union team.

FIG. 7 originated by the inventor, is a current list of NFL teams in the U.S. including a match-up of the highest level non-profession rugby union teams, including both Division I men's clubs (also those from ARP/PRP & the Seattle Saracens) and Division I-A/I-AA colleges (unless otherwise indicated), in their respective geographical regions.

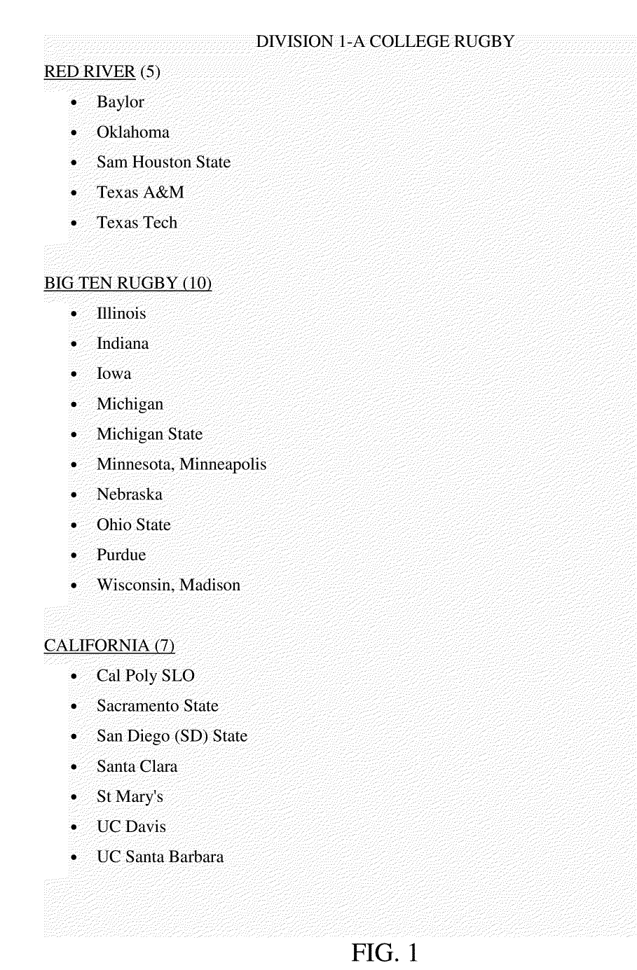

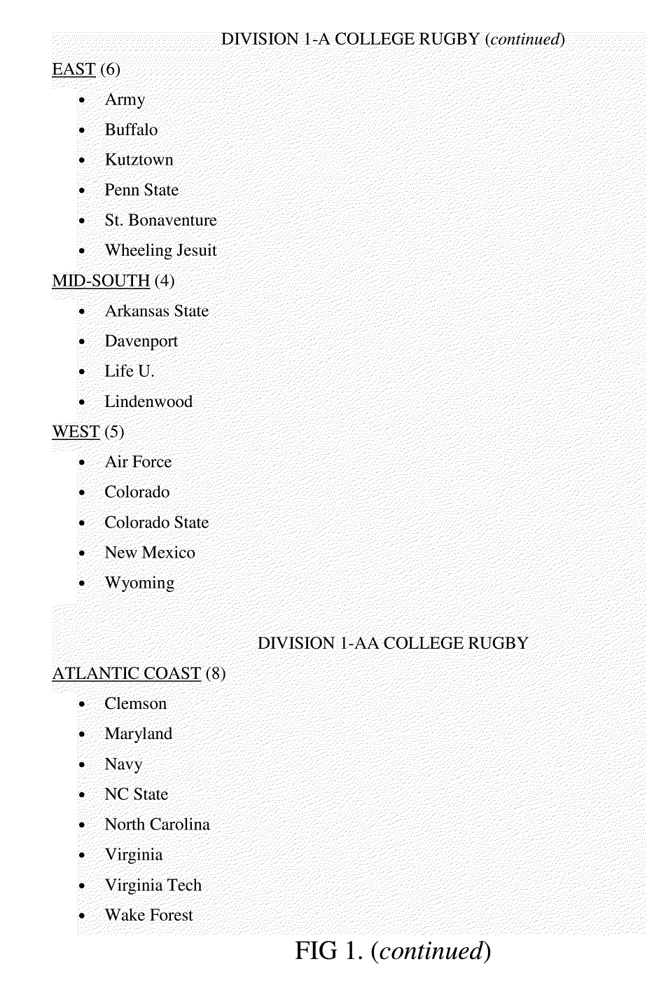

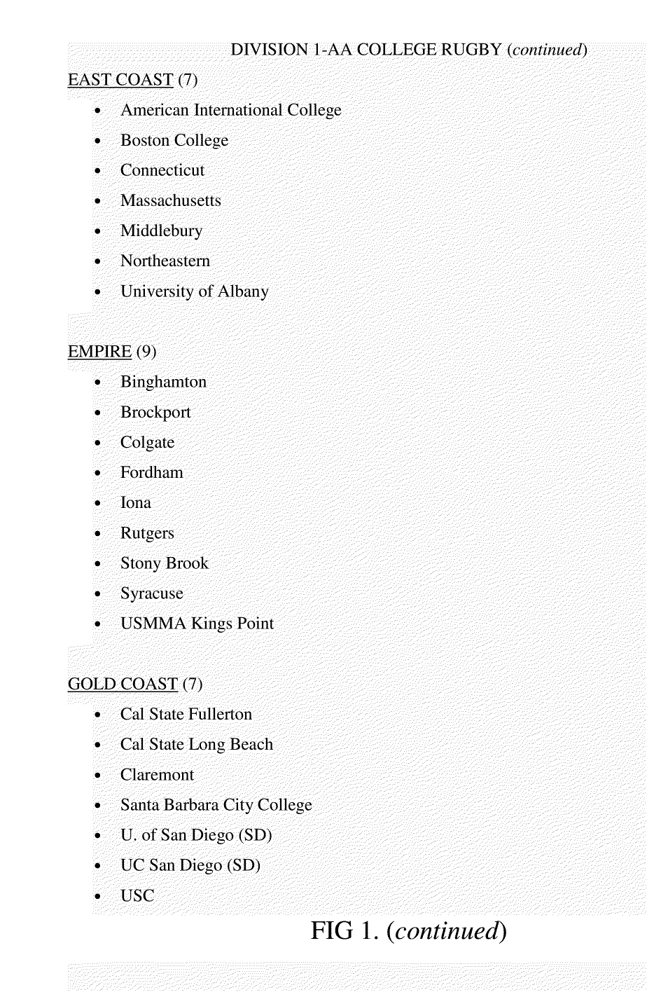

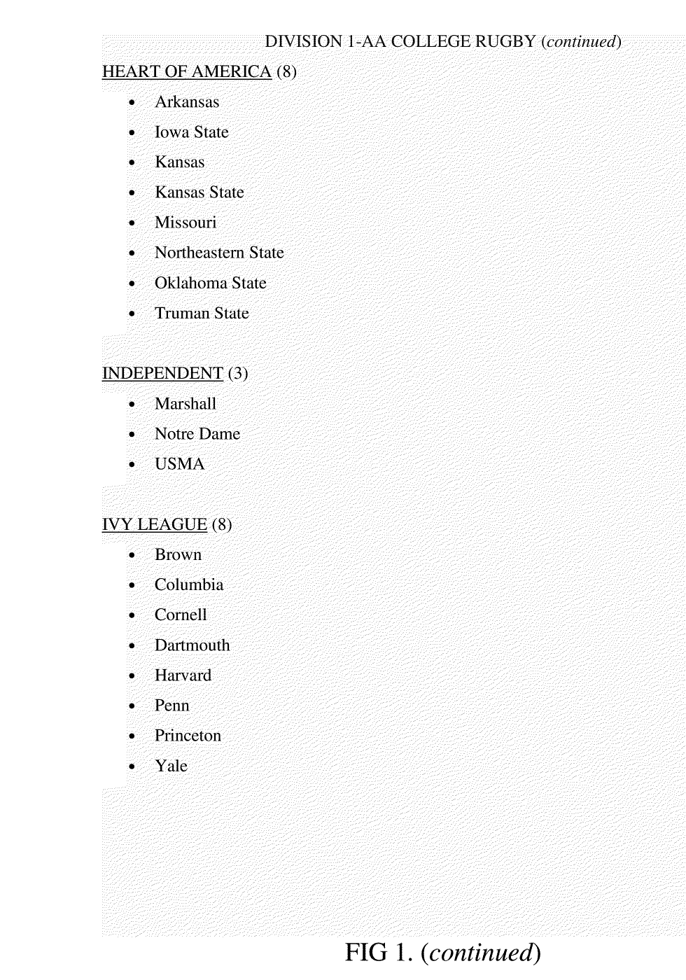

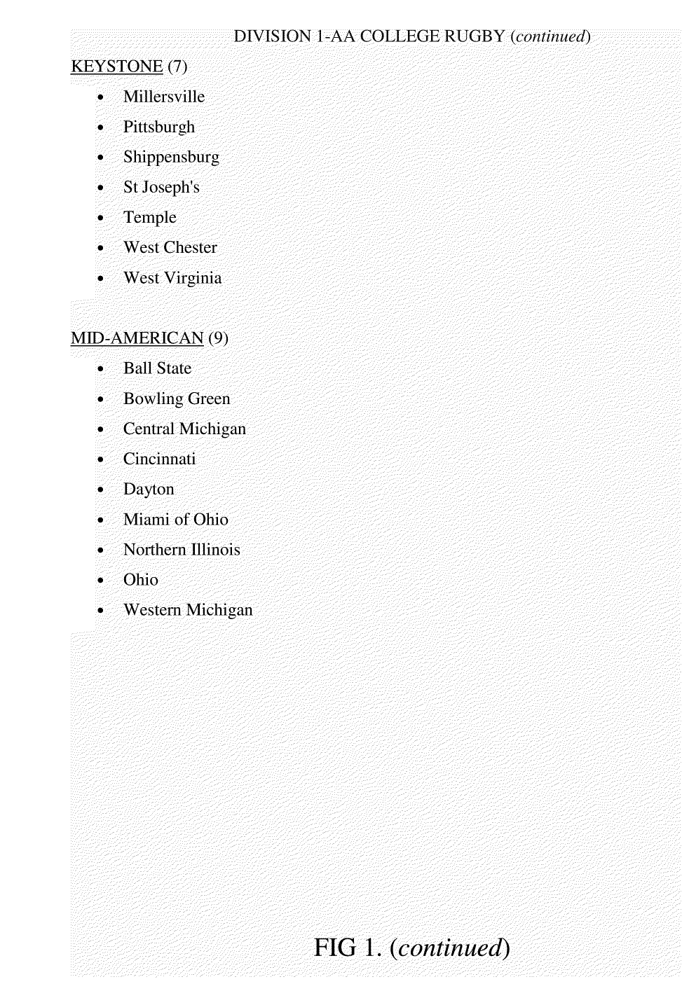

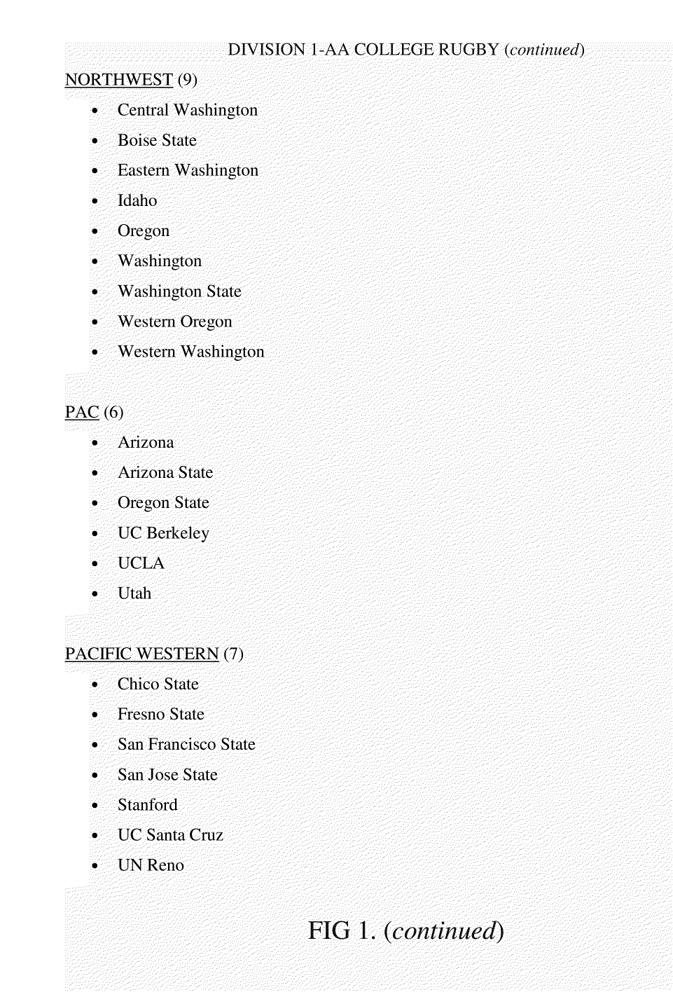

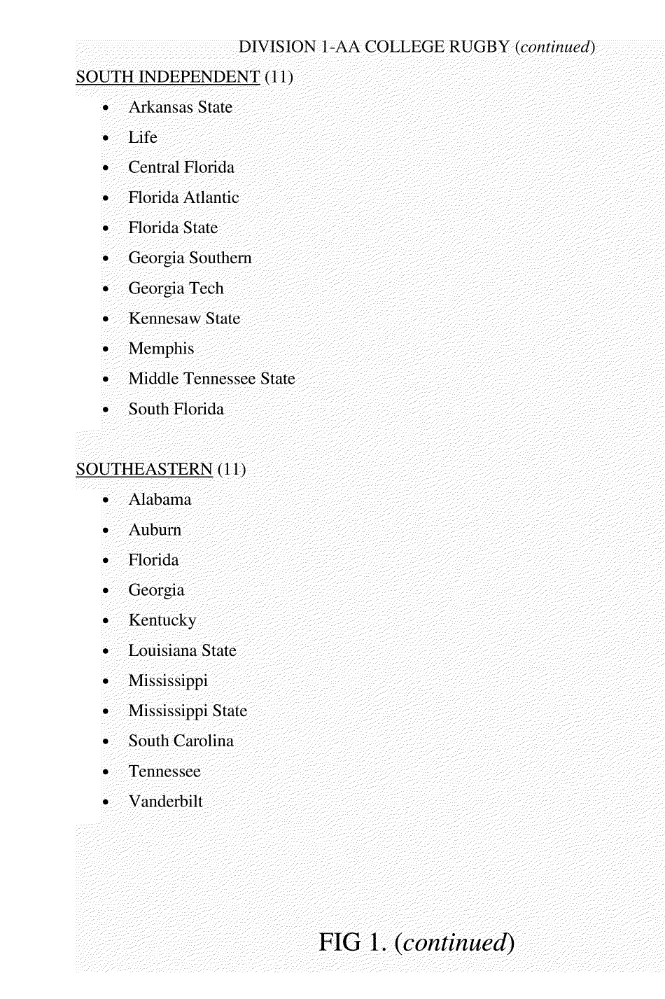

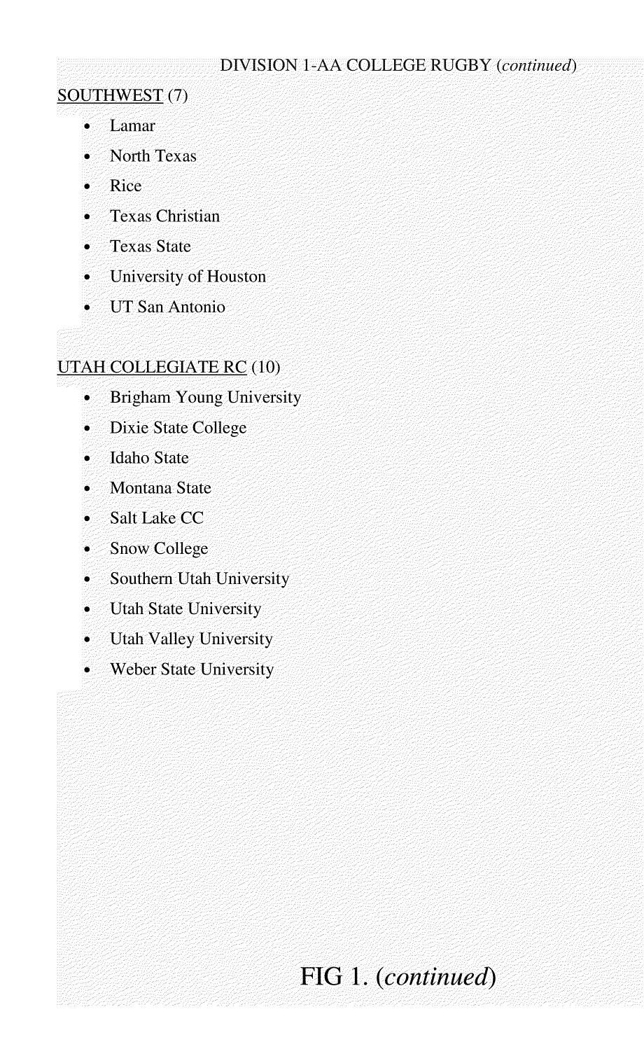

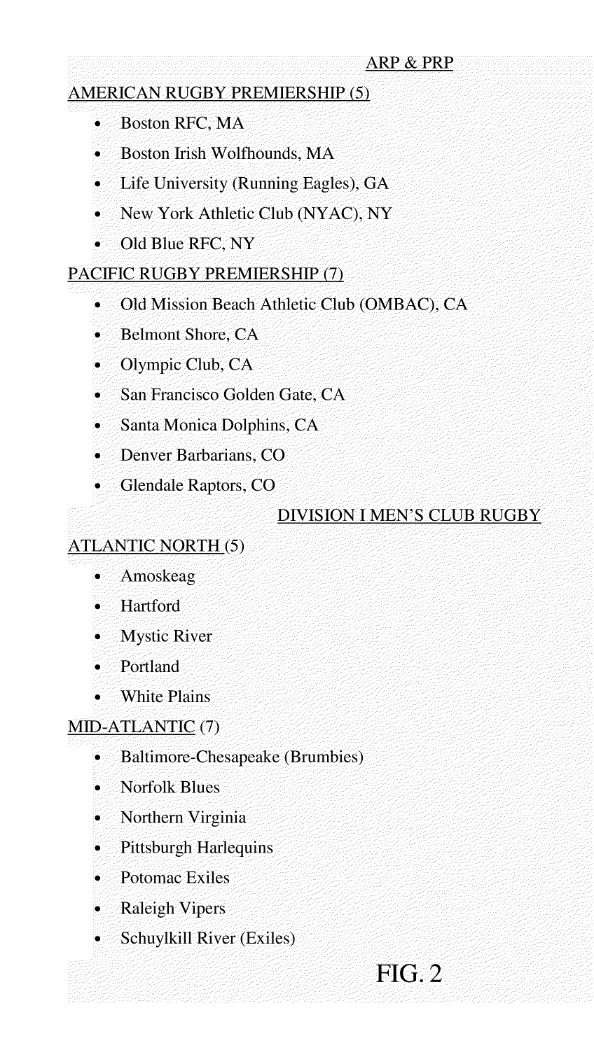

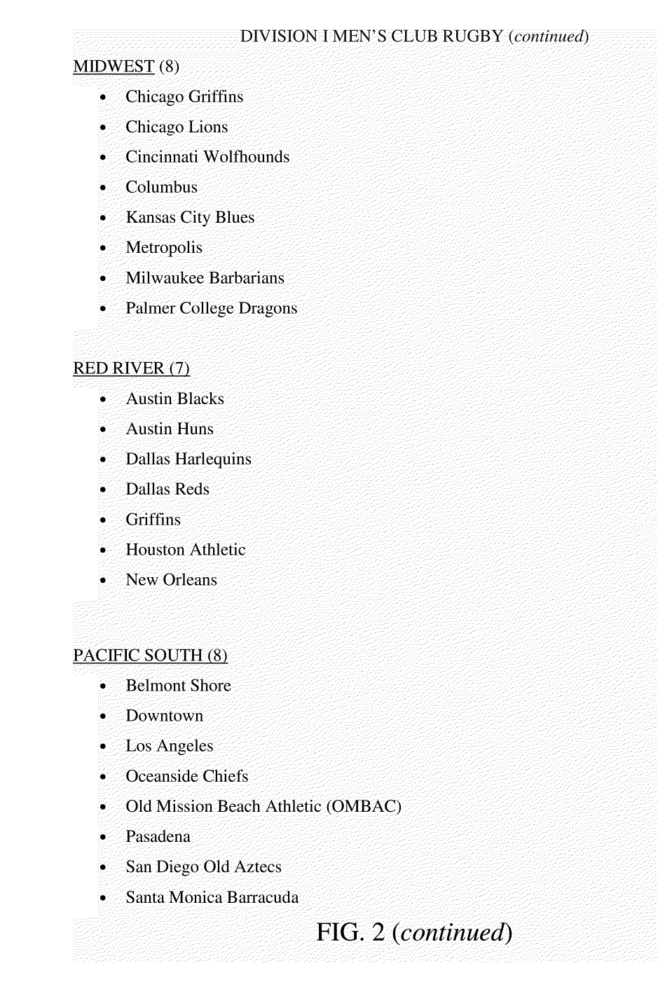

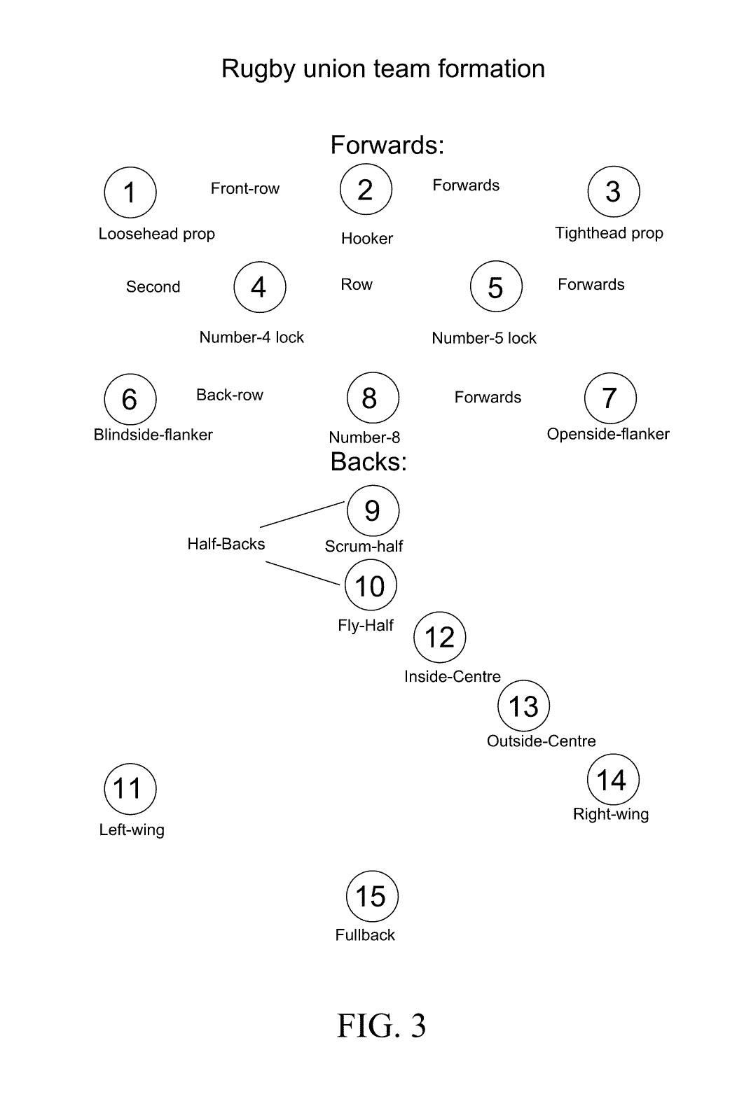

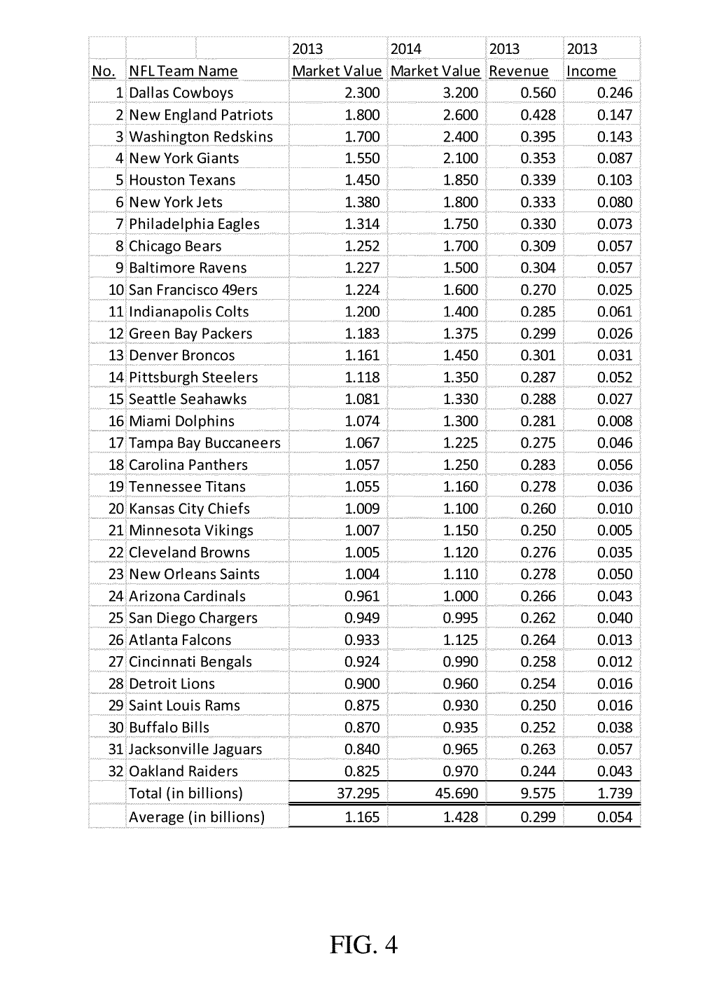

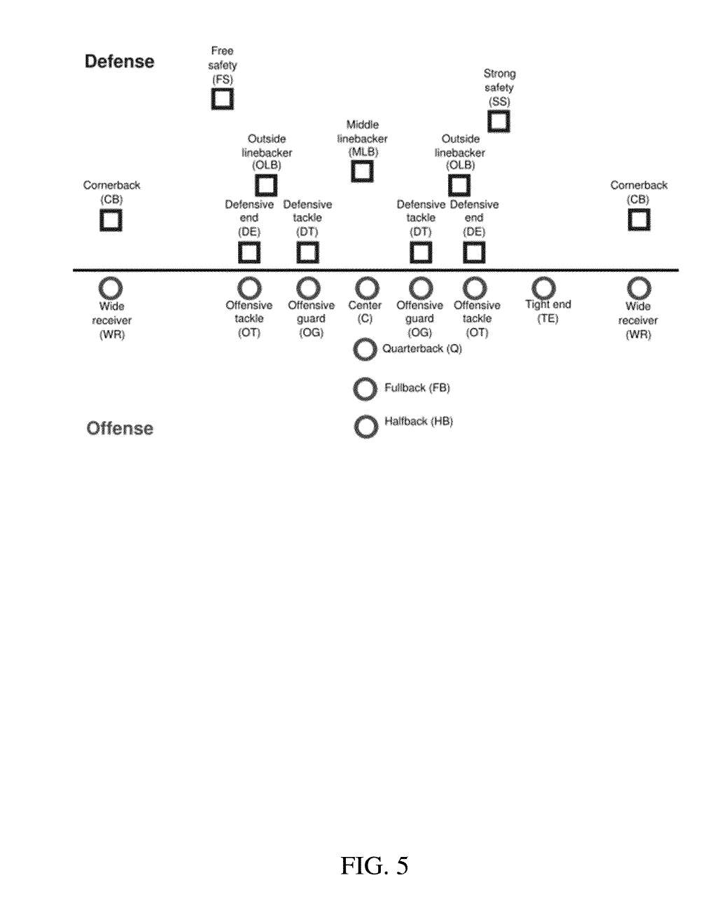

FIG. 8 originated by the inventor, shows a modified Rugby union team formation, based on a combination of experienced rugby and NFL players:
Vertical-lined shading—rugby positions (1), (2), (3), (9) and (10) would typically be pure rugby recruits or those who bring concrete experience from top international professional, national collegiate or existing men's club players (from other teams).
Cross-hatch shading—rugby position (4), (5), (6), (7), (8), (11), (12), (13), (14) and (15) could be filled from existing NFL roster [e.g. 2nd/3rd string, see FIG. 5. for definitions of (TE), (WR), (OLB), (MLB), (WR), (FB), (HB), (CB), (SS) & (FS) as well as (RB) for Running Back or (FB) & (HB), (DB) for Defensive Back or (CB), (SS) & (FS) and (KR) for Kick Returner and Punt Returner], or top international professional, national collegiate or existing men's club players (from other teams).

FIG. 9 originated by the inventor, shows later phases for NFL team to improve its own rugby union team.

FIG. 10 illustrates a block diagram of a computing device with which some embodiments may operate.

### DETAILED DESCRIPTION

The inventor has recognized and appreciated that there is a substantial opportunity for instituting and growing a U.S. professional rugby union league, with a popular following in the U.S., through integrating and expanding the resources of existing American football teams, such as NFL teams, with their own rugby teams into an existing non-professional rugby union league (e.g., ARP/PRP) or any proposed and newly established professional rugby union leagues. The American football resources that may be used in a new rugby union team may include both physical and intellectual property resources of an NFL team (e.g., stadium and brand name of such team), as well as the human resources of an NFL team (e.g., players and support staff of such team). (Below, unless otherwise stated, “football” should be understood to refer to American football and “rugby” should be understood to refer to rugby union.)

The inventor has recognized and appreciated that, despite the commercial success and profits of American football teams, the resources of these NFL teams are underutilized. Increased utilization of these resources may increase the profits of the NFL teams. The inventor has recognized, however, that NFL teams have currently saturated the U.S. market, and it would be difficult for such teams to increase utilization of their resources by using them further in an American football market. In addition, the Supreme Court ruled in May 2010 that, “Although NFL teams have common interests such as promoting the NFL brand, they are still separate, profit-maximizing entities, and their interests in licensing team trademarks are not necessarily aligned.” Accordingly, the inventor has recognized and appreciated that, as NFL teams have the ability to act on their own behalf, the teams should use their brand to invest in a rugby union team to compete in either an existing non-professional league (e.g., the ARP/PRP) or any proposed and newly established professional league during the spring/summer, just as individual NFL players should be able to play another professional sport (e.g. baseball) in the off season. Also, in light of the more serious long term effects of concussions that have been suffered by American football players, as confirmed by the NFL via its settlement agreement with affected players in August 2013, the NFL teams (and their players) would benefit from a diversification strategy that is complementary to their existing business model (and career model, respectively).

The inventor has recognized that some resources of an NFL team/club may be advantageously used in a rugby union league and that doing so could increase utilization of such team/club's resources while enabling the creation of rugby teams. Though, the inventor has recognized that due to the inherent differences between American football and rugby union, and the resultant differences in the needs of the two sports, a rugby team may not successfully operate only using existing American football (e.g., NFL) team/club resources. For example, the inventor has recognized that a rugby team from the beginning may successfully compete with a lineup of players that includes players with prior rugby experience, but with little or no American football experience. However, the inventor has further recognized that such a rugby team may benefit from having American football players in particular positions on a rugby field, while having experienced rugby players in other positions. By doing so, the rugby team may benefit from the resources of the American football team/club, and such team/club may benefit from increased utilization of its resources.

Accordingly, described herein are techniques for building and improving a professional U.S. rugby union league, and related teams of such a league, using particular resources of American football teams/clubs. Such team/club resources may, in some embodiments, be combined with resources that are specific to rugby. For example, in some embodiments, a rugby team may operate using physical resources of an NFL team/club, such as by playing in a stadium owned and used by this team/club. As another example, a rugby team may include both players with football backgrounds and no prior rugby experience, as well as players with prior rugby experience.

Rugby has been played in the U.S., but to date has had limited popular support. Only Rugby sevens which will be an Olympic sport in 2016 has some degree of momentum at the collegiate level and at the national level as the Eagles have also moved to the top 10 in global rankings. Also, public interest in rugby union may get a boost of support at the national level with the Eagles who recently played against the All Blacks in a one time event at Chicago's Soldier Field on Nov. 1, 2014. They are due to participate in the World Cup in 2015 but their ranking has consistently remained just within the top 20 in global rankings for some time. Also, rugby union at the college level has some support with the Varsity Cup final being held every May since 2013. However, rugby union at the men's club or non-professional level remains out of the public eye as neither the ARP nor the PRP has earned major broadcasting coverage. The inventor has appreciated from the rise of American football, however, that there is an opportunity to expand the role of rugby union in professional American athletics. A hurdle to the expansion of rugby union in the U.S. is resources necessary for expansion. Due to the lack of support for rugby union in the U.S. in the past, there is a shortage of potentially top level talent for new rugby union teams. Further, new stadiums designed specifically for the sport and other physical resources for such a rugby team require a large capital investment, which may be difficult to obtain given the limited status of rugby in the U.S.

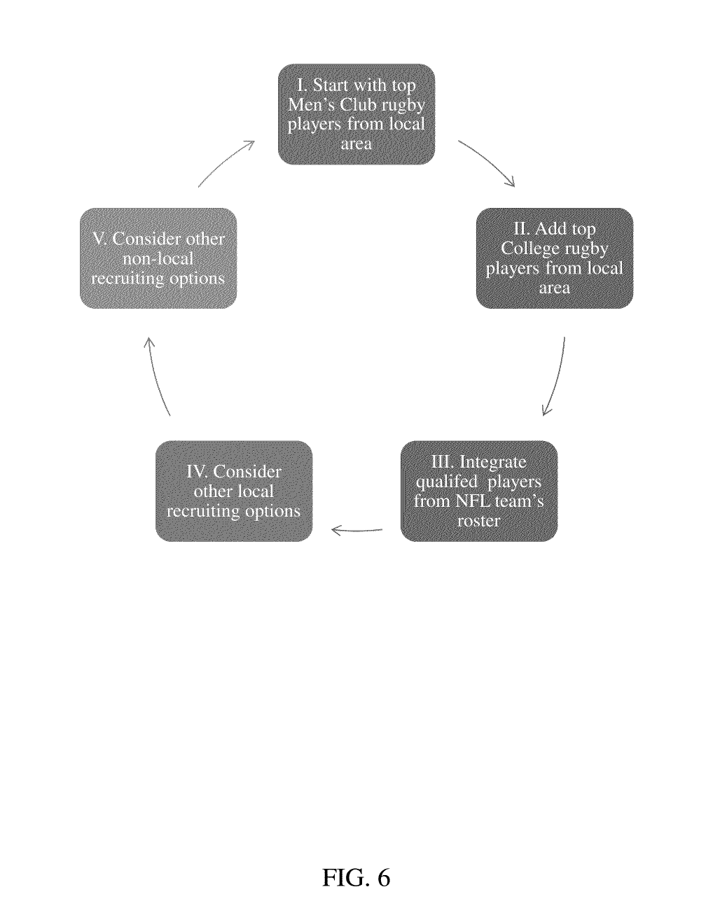

Described below are various examples of techniques that may be implemented to develop a U.S. professional rugby union league, and teams of such a league, but it should be appreciated that embodiments are not limited to being implemented in accordance with these techniques. Rather, the techniques discussed below in connection with FIGS. 6-9 provide illustrative examples of ways in which embodiments may operate. In examples below, an American football team/club that is forming a rugby team is described as an NFL team, but it should be appreciated that embodiments are not limited to operating with the NFL or with NFL teams/clubs and may be implemented with American football teams/clubs in other leagues. For example, a new professional rugby union league could be launched first with private investors who recruit players for different teams from the best non-professional men's club teams and colleges from their respective geographic regions. Thereafter, an NFL team could buy into an existing franchise as a partner, and/or ultimately buy the whole rugby team when moving toward the next step of integrating its own qualified players onto the rugby team. Further, while the American football team/club is referred to simply as a “team” (or, in the example of the NFL, an “NFL team”), it should be appreciated that references to the “team” also refer to the attendant operations and resources of such professional football team/club. Meanwhile, the aforementioned attendant operations and resources may include, for example, healthcare operations/resources, financial operations/resources, marketing and public relations operations/resources, and any other operations and resources currently in use by professional football teams.

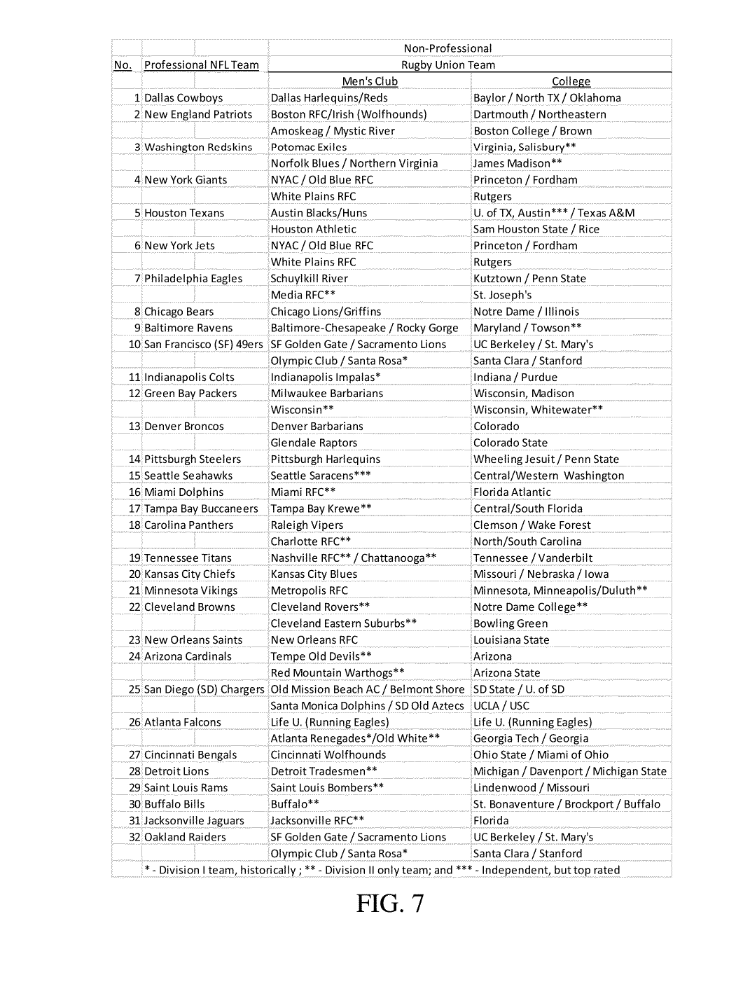

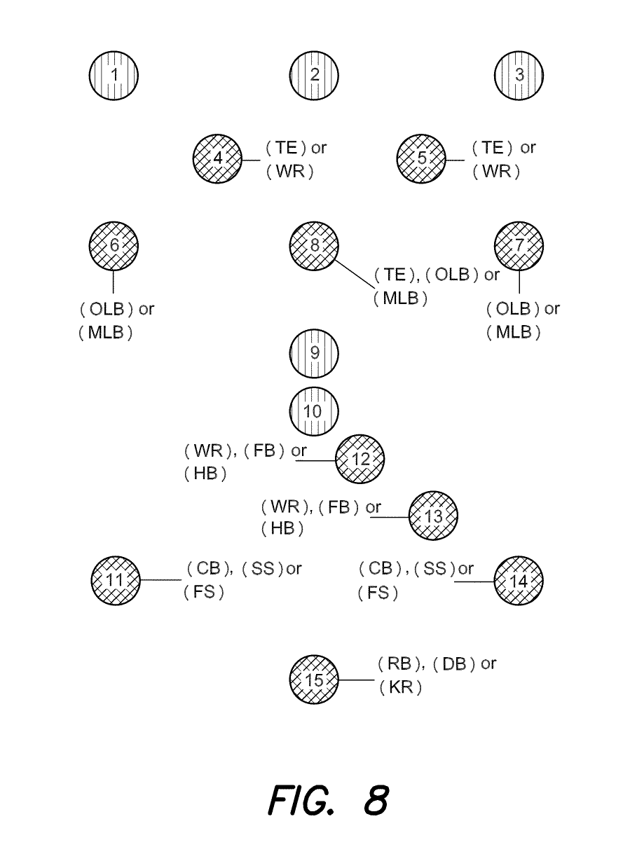

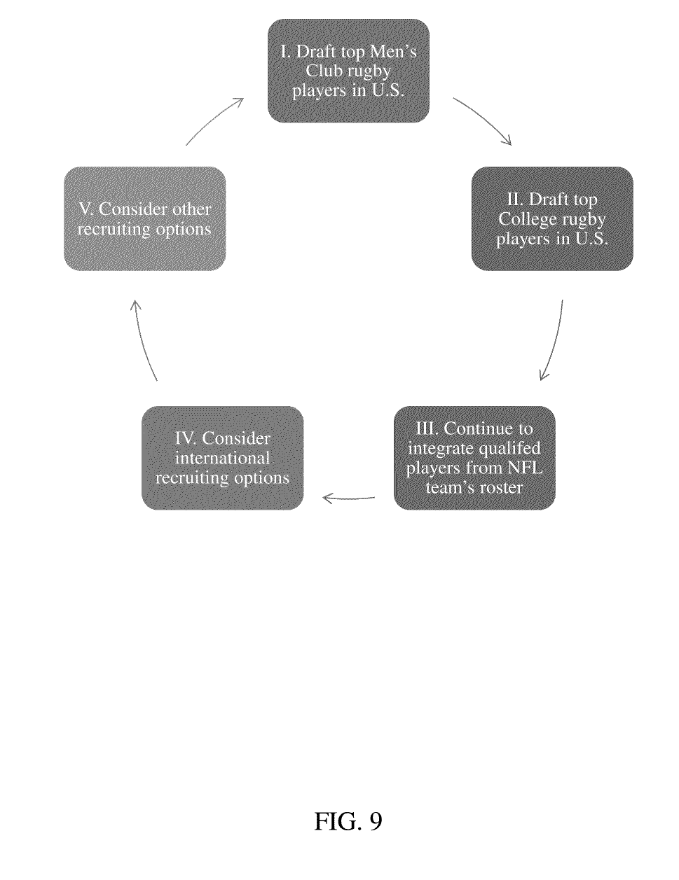

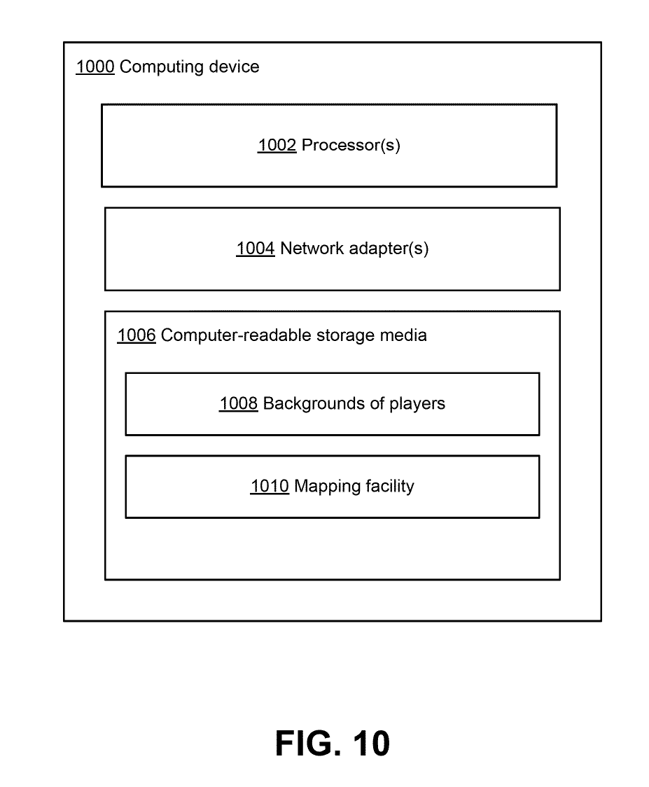

FIG. 6 shows some phases/actions (I-V) an NFL team may take in some embodiments to build its own rugby union team at any time. As previously stated, in some embodiments the starting point may be one or more NFL teams identifying and recruiting the best non-professional men's club teams (Phase I) as well as the best college players (Phase II) within their respective geographic region. Before the integration of any players from an existing NFL team roster (Phase III), the rugby team should have in place a starting team and roster of experienced players for each position who would be able to compete immediately. Thus, these first two phases could be carried out by private investors who invest in a new professional rugby union league and create their own teams before seeking a formal partnership, investment or buyout from an NFL team. In that regard, FIG. 7 is a current list of NFL teams in the U.S. including a match-up of the highest level non-profession rugby union teams, including both Division I men's clubs (also those from ARP/PRP & the Seattle Saracens) and Division I-A/AA colleges (unless otherwise noted), in their respective geographical regions. Though the 5 phases and categories of actions in FIG. 6 could be implemented by an NFL team at any time, an advantageous time for formally doing so may be just after the national championship game for Division I men's club in early June. This timing would enable the NFL team to exercise certain alternative plans. For example, in Phase I, it could effectively start by taking over an entire local men's club team or by just recruiting certain players from such team(s). Also, in Phase II the NFL team could add certain graduating seniors from the local college(s), such as those who were All-Americans or Honorable Mentions according to USA Rugby. Either way, the NFL club/team organization would then have a full rugby union team roster with experienced top men's club and college level players for a later test match. On game day, its rugby team roster could be up to 23, which should include 3 starting and 3 back up players for the front row, who must be suitably trained and experienced rugby players. In other words, 5 additional back up players on game day could be used to cover any of the other 12 positions if and when a starter gets injured or needs to be replaced. This first rugby union team under the NFL team's existing or new individual logo and brand name could then be ready to play in certain test matches at home in the fall and with a limited schedule that is not in direct conflict with the NFL team's (American football) playing schedule.

As discussed in the background section, rugby union and American football are different sports with different needs and, as such, the resources used for American football are different from the resources used for rugby union. However, the inventor has recognized and appreciated that rugby union teams may benefit from some of the underutilized resources of NFL teams. By tapping into such resources, rugby teams may be able to overcome the resource deficits that are currently impeding expansion in a general and in a professional manner. Additionally, NFL teams/clubs may benefit from increased utilization of their resources, as increased utilization may increase the profits gained from these resources.

Accordingly, beyond the NFL team having the financial resources to build its own professional rugby union team when adopting and implementing Phase I and II, the inventor has recognized that other resources of NFL teams are underutilized and could be put to use further in Phase III. For example, the inventor has deduced that the underutilization of football resources such as player and stadium capacity during their off season (i.e., from February to July) creates an opportunity for further building and testing out their own rugby union teams. For example, since the spring season of the ARP/PRP or a newly created league could start around mid-March every year, the NFL team would have a 6 week time frame from early February to prepare certain select players from its existing (American football) roster to be a part of its rugby union team. While 1^{st} string NFL players must prioritize their commitments to the NFL team itself, the 2^{nd} and 3^{rd} string players, as well as the 8-man practice squad, may be candidates for the rugby union team as (i) they are non-starters who are not fully utilized during the NFL regular season games and (ii) if they meet the qualifications, they should be fully available to act at least as 2^{nd} or 3^{rd} string players on such rugby team. This way, the NFL team is able to tap into and optimize its talent pool when investing in this complimentary sport to American football (rugby union) and during a complementary time frame (from February to July).

In terms of specifically identifying the rugby union positions where there is a beneficial overlap from the skill sets of American football positions, FIG. 8 shows a modified Rugby union team formation based on a combination of experienced rugby and NFL players. In that regard, the following is a discussion of 10 relevant rugby positions (labeled (4)-(8) and (11)-(15) in FIG. 8) where NFL players may have an opportunity to try out in some embodiments. It should be appreciated that, in some embodiments, NFL players may be able to operate in positions other than (4)-(8) and (11)-(15), and that embodiments are not limited to operating with any specific arrangement or combination of rugby players and NFL players.

“Lock” ((4) and (5)): Integrating NFL players into the rugby union “lock” position should be straightforward when one considers the attributes of tight ends (TE) or wide receivers (WR). Although there is a defensive component to the lock position as he would be expected to tackle the opposing side's locks and other forwards, his main role is to push against the front row and provide much of the power. Thus, a tight end, who is typically bigger and broader than a wide receiver, could be better suited in qualifying for this job. However, they both have the basic physical attributes expected of locks, which include being the tallest players on the team. In that regard, just as TE's and WR's need to be able to catch passes from quarterbacks, locks need to be able to catch the ball when it's thrown in at line-outs. Also, a tight end with his size could also be more adept at performing this job than a wide receiver as he would be expected at times to run with the ball through defending forwards.

“Flanker” ((6) and (7)): Integrating NFL players into the rugby union “flanker” position should be straightforward when one considers the attributes of linebackers, e.g., OLB or MLB. Both flankers and linebackers need to be physically fit and good at reading the opposing side's attacking plays. Their collective role is to tackle the opposition and try to steal the ball so linebackers should qualify as flankers. Also, just as linebackers rush the opposing side's quarterback in forcing him to release the ball, flankers charge the opposing side's fly-half in pressuring him to either kick or pass the ball.

“Number-8” ((8)): Integrating NFL players into the rugby union “number-8” position should also be straightforward when one considers the attributes of linebackers, e.g., OLB or MLB, and tight ends (TE). Both of the number-8 and linebacker/tight end players are strong and are expected to push past the opposition's defensive line when running with the ball. Also, a linebacker qualifies for this position (as the lone forward in the back of the scrum) as he has the skills needed to tackle the opposing side's number-8 and other forwards. In addition, a number-8 can be a target when the ball is thrown in toward the back of line-outs so a tight end should have an edge here over linebackers with respect to good catching ability. At the same time, the remaining challenge for a tight end (but not for a linebacker) would be to handle the man-to-man defensive component of the number-8 position. This may or may not be an easily acquired skill depending on the specific candidate. Meanwhile, the only other role of the number-8 is to pass or flick the ball off to the scrum-half when possible and the task here should be an easily acquired skill.

“Centre” ((12) and (13)): Integrating NFL players into the rugby union “centre” position should be straightforward when one considers the attributes of wide receivers (WR) or running backs, e.g., HB or FB. While the centre position is primarily an offensive rushing position, there is a man-to-man defensive component. Meanwhile, the WR or running back positions are only offensive ball catching and carrying positions with no defensive component. However, the specific ball rushing attributes are collectively the same as they are all expected to be elusive and agile runners. A fullback and halfback from American football could be positioned as an inside-centre and outside-centre, respectively, as the latter in both cases is expected to be faster and have more room to run as a ball carrier. However, there could be flexibility in flipping centre positions here as there is no big difference in either of their respective roles and it could be deemed necessary to do so (e.g. to have better match ups of the team's players with the opposing side's starting centre positions). Also, as running backs are typically shorter and broader than wide receivers, they are typically better trained at running straight lines through defenders when rushing with the ball, so they could be better suited in qualifying for this job. At the same time, the remaining challenge for a WR, HB or FB would be to handle the man-to-man defensive component of the centre position. This may or may not be an easily acquired skill depending on the specific candidate.

“Wing” ((11) and (14)): Integrating NFL players into the rugby union wing position should be straightforward when one considers the attributes of defensive backs, i.e., CB, SS, or FS. While the wing position is primarily a fast paced offensive position, there is a man-to-man and zone defensive component to it. While the defensive back position is primarily a fast paced defensive position, there is an offensive component to it. Thus, the two different positions from the two different sports are nearly aligned as both are expected to be the fastest players on the team. On the one hand, they both need to be good at catching the ball and quick at running with it. On the other hand, they also need to cover the opposing side's runner on their side of the field (in either man-to-man or zone coverage) and be able to tackle him. In terms of added skills to be assessed, the defensive back would also need to have the following to qualify as a wing: (1) kicking the ball downfield, when he's running with the ball on offense, (2) passing or pitching the ball to teammates in support from behind, when he's running with the ball on offense and (3) punting the ball out of bounds as a defensive move when he's catching the ball deep in his own territory.

“Fullback” ((15)): Integrating NFL players into the rugby union “fullback” position should be straightforward when one considers the attributes of running backs (RB) and defensive backs (DB), especially if they also act as the kick returner or punt returner (KR) on the team. This position is one of the most dynamic available as, on the one hand, he must be the last line of defense against runners from the opposing side and be able to catch high kicks deep in his own territory and, on the other hand, be able to punt the ball a long distance with accuracy as a defensive move or to run with the ball and coordinate well with the other backs in a counter attack move. Accordingly, he is typically not only the team's best punter, but also the team's field goal and penalty kicker. However, this latter skill is not necessary if the fly-half or another player has such skill. Thus, RBs and DBs who can catch highly kicked balls as well as KRs would be candidates for fullback on the rugby team, assuming they are good enough in tackling and great in punting. Accordingly, in light of the tackling demands, DBs who also act as KRs would have an edge over RBs and KRs in general when qualifying for this rugby position especially if they are great in punting too. A mitigating factor here is that the rugby fullback is not expected to be the fastest player on the team. However, he should have the necessary speed and skill to work well with the other backs.

There could be other possibilities other than those outlined above, however, in such cases additional skill sets by the player would need to be further assessed or acquired and other considerations would need to be addressed. For example, both a tight end and a number-8 are strong and are expected to push past the opposition's defensive line when running with the ball. However, the extra skill needed by a tight end to fulfill properly the rugby position is being able to tackle the opposing side's number-8 and other forwards, especially since he is the lone forward in the back of the scrum. In addition, for example, in light of the additional challenge for a wider receiver or running back to handle the man-to-man defensive component of the centre position, defensive backs, who already have this skill set, could also be candidates for the centre position. However, if there is a limited supply of defensive backs on the team, they should be prioritized toward the wing and fullback positions.

The following is a discussion around the 5 rugby positions (labeled (1)-(3) and (9)-(10) in FIG. 8) where experienced rugby players have an upfront advantage over NFL players and therefore may be prioritized for being filled with rugby players in some cases. However, it should be appreciated that embodiments are not limited to operating with rugby players in these positions and that there could be an opportunity for integration of NFL players in some cases. For example, if certain NFL players trying out (i) brought a much needed skill set to the team that fit with the rugby position in question, (ii) had some rugby related experience in the past so would be quick learners and/or (iii) were able to grow into the specific rugby position over time with suitable and/or extra special training and experience, these NFL players may be placed in these positions.

“Prop” ((1) and (3)): As this is a front row position, rugby union rules require that the player is suitably trained and experienced. Thus, an immediate NFL player candidate would be someone who had some prior rugby experience in this specific position. Also, offensive lineman (e.g., C, OG, or OT) and defensive linemen (e.g., DT or DE) have blocking skills, which could be beneficial as a prop who is expected to absorb the opposition's force and try to move the scrum forward. Also, defensive linemen know how to tackle, which is a necessary skill as a prop, so they have an additional skill over offensive linemen. In terms of physique, offensive and defensive linemen are on average bigger versions of props, who typically have short necks, broad shoulders and powerful legs. On the one hand, this may appear to be an advantage. However, on the other hand, rugby union is more of an endurance sport than American football. Thus, offensive and defensive linemen may not be able to meet the cardiovascular demands of constant running. In addition, they shouldn't be grossly bigger than the hooker as their job is to prop him up in the scrum and provide stability in the scrum. Either way, offensive and defensive linemen with no prior rugby experience in the prop position would require suitable and extra special training and experience, which could be a fruitless endeavor.

“Hooker” ((2)): As this is a front row position, rugby union rules require that the player is suitably trained and experienced. Thus, an immediate NFL player candidate would be someone who had some prior rugby experience in this specific position. As the main role of the hooker is to use his feet to hook the ball back and win possession for his team, the specific skills of the kicker from American football could be a potential candidate, especially if the rugby union team needs an extra person to make field goal and penalty kick attempts. In terms of physique, the kicker and the hooker are typically the smallest players on their teams. However, a hooker from rugby union is expected to run effectively on offensive plays and tackle effectively on defensive plays, while a kicker in American football is not expected to do so in both plays. Either way, kickers with no prior rugby experience in the hooker position would require suitable and extra special training and experience, which could be a fruitless endeavor.

“Scrum-half” ((9)): As this is not a front row position, rugby union rules do not require that the player is suitably trained and experienced so it would be easier to grow an NFL player into this position. However, as he is directing the forwards around with the aim of getting the ball from them and passing it to the backs, it is a leadership position. He makes tactical decisions on the field in addition to the fly-half. He also needs to be able to tackle his opposing scrum-half. Thus, an immediate NFL player candidate would be someone who had some prior rugby experience in this specific position. Meanwhile, he should be excellent at passing, good in tactical kicking and deceptive as a ball carrier. Thus, the skill set of the American football quarterback (Q), who is the leader of the offensive side with great ball handling skills, could be beneficial as a scrum-half. Either way, quarterbacks with no prior rugby experience in the scrum-half position would require extra special training and experience, which could be a fruitless endeavor.

“Fly-half” ((10)): As this is not a front row position, rugby union rules do not require that the player is suitably trained and experienced so it would be easier to grow an NFL player into this position. However, he is the leader of the backs and a key decision maker. He also needs to be able to tackle his opposing fly-half and is often times the team's field goal and penalty kicker. Thus, an immediate NFL player candidate would be someone who had some prior rugby experience in this specific position. Meanwhile, he should have good passing and kicking skills while running. Thus, the skill set of the American football quarterback (Q), who is the leader of the offensive side with great ball handling skills, could be beneficial as a fly-half. Either way, quarterbacks with no prior rugby experience in the fly-half position would require extra special training and experience, which could be a fruitless endeavor.

As a result of Phase III (shown in FIG. 6 and discussed above) and the integration of NFL players into a rugby team roster, the NFL participating players who make the rugby union team even as back-ups in the beginning would bring a new legitimacy to either the ARP/PRP or a newly established league as a professional level competition. If and when they become experienced rugby players as well as starters, these NFL players would be able to reach their full earning potential in a double or second career as professional rugby players. Also, the participation of at least one NFL team with its own rugby union team, which included a mix of players from its existing football roster (Phase III) as well as other rugby recruits (Phase I-II), would enable such team with its branding power to attract its season ticket holders and fans to the sport. Meanwhile, the participating NFL teams are currently under utilizing their stadiums, which could be hosting grounds for home rugby games in the spring season, including a final championship match. Doing so would yield higher revenue in all categories (e.g. ticket sales, broadcasting revenue, corporate sponsorship and merchandising/licensing deals, among other things). As the current schedule for such a competition would be only from mid March to the end of May (in light of only 12 teams competing in the ARP/PRP), the extension of this schedule to June or July would most likely be inevitable due to more teams competing, but that would only be of financial benefit to each team and its players.

Phase IV and V of FIG. 6 illustrate that an NFL team that is building its own rugby union team should also consider other local and non-local recruiting options. These two phases may be less important in some embodiments in comparison to Phases I-III, where an NFL team builds a professional rugby union team with a mix of experienced players and ones from its existing roster. Nevertheless, in some environments in which techniques described herein are implemented, the actions of Phase IV and V may represent important considerations. For example, when considering other local recruiting options under Phase IV, one possibility is that certain players on the men's national rugby team (the Eagles), who are from the local area, are already competing in professional rugby union leagues overseas. If their contracts are due to expire, with the appropriate offer they might be persuaded to return to their respective home town/city to join a professional rugby union team located nearby. The same could be said for top rugby union players who are currently serving active duty in the Air Force, Army, Navy, etc. If and when their military service commitments are due to expire, they could be persuaded to return back to their respective home town/city to join a professional rugby union team located nearby. When considering other non-local recruiting options under Phase V, one possibility is to identify and recruit certain international players from professional rugby union leagues overseas. If their contracts are due to expire and with the appropriate offer, they could be persuaded to move to the U.S. to be a part of building a professional rugby union team and league there.

Phase V of FIG. 6 is a lead into FIG. 9. FIG. 9 shows later phases for an NFL team to improve its own rugby union team. After an NFL team has successfully built a competitive team for either the ARP/PRP or a newly established professional league, the future ongoing model for improving it may be adopted and implemented, such as after the end of the season. However, the later phases could be adopted and implemented at any time and could be an ongoing process.

For example, Phase I relates to going beyond the local area in the U.S. to draft certain players from the top of the men's club divisions. A starting point here could be looking at certain players on the men's national Eagles team, who are also competing elsewhere in the U.S. for different men's clubs. Phase II relates to going beyond the local area in the U.S. to draft certain players from the top of the college divisions. A starting point here could be looking at certain players on the men's national Eagles team or USA Rugby's list of collegiate All-Americans and Honorable Mention Collegiate All-Americans, who are also competing elsewhere in the U.S. for different colleges. Phase III here is a continuation of Phase III from the initial phases. The integration of certain NFL players into the rugby union team will be an ongoing process. Initially, those who qualify will most likely start off as back up players, e.g., 2^{nd} and 3^{rd} string rugby players as certain primary obstacles need to be gradually overcome in the transition from an NFL player to a professional rugby union player. For example, while American football is a game of inches with protective equipment, rugby union is a game of possession with barely any equipment, so the pace of the games are different and tackling styles must be modified accordingly. While the former results in full speed contact on each and every play, the latter results in more fluid contact in more constant play. However, with extra training and experience over time, these particular players can evolve and develop further into starters. Also, the NFL careers of some may not stand the test of time in the shorter term, but their rugby union careers may continue to blossom in the longer term, especially since rugby players are less prone to have serious injuries, such as concussions, in comparison to American football players. In addition, as the NFL team continues to recruit new players from colleges for its core roster there will be an opportunity to start the integration and evaluation process all over again for such players into its rugby roster. Phase IV shows that seeking out international players from overseas professional leagues will actually become more and more important as the U.S. professional rugby union league becomes more successful financially and the team can afford to recruit better and better talent. In that regard, it would typically be a longer recruiting process as they would need to be free of contractual commitments to be eligible in the first place. However, in this case, eligible players can be either top Americans (e.g. Eagles) or foreigners who are competing well abroad. Phase V illustrates a recognition that there are other recruiting options such as top rugby union players who are currently serving active duty in the Air Force, Army, Navy, etc. If and when their military service commitments are due to expire, they could be persuaded to join a professional rugby union team in the U.S.

In conclusion, with even one NFL team/club organization adopting/implementing the inventor's business model for building and improving its own professional rugby union team to join/compete in a legitimate league (e.g. ARP/PRP or a newly established one), then such competition would automatically be instituted as a professional rugby union league in the U.S. The growth for this league would come if and when any other or all 32 NFL team/club organizations also decided at some point to adopt/implement the inventor's business model and join/compete with their own rugby union teams. Finally, if and when all 32 NFL team/club organizations have joined this U.S. professional rugby union league, then both this league and the NFL would effectively be entities under common control.

### Exemplary Implementation

The techniques described herein may be implemented in a variety of ways, some examples of which are discussed above. One specific way in which the techniques may be implemented is discussed below. It should be appreciated, however, that embodiments are not limited to implementing this specific technique, as other implementations are possible.

In some embodiments, a rugby league operates through sharing resources with one or more American football leagues. The rugby league and the American football league(s) may each include multiple teams. In some embodiments, each rugby team of the rugby league may be associated with and share the resources of one of the football teams of the football league(s), such that there may be a one-to-one correspondence between rugby teams and football teams. The teams may be associated through common ownership (e.g., the owners of the football team owning the rugby team, or the football team owning the rugby team) and/or through sharing of resources (human, physical, intellectual property).

In some cases, the rugby league and rugby teams may be in operation at a time that they are associated with the football league/teams. In this case, rugby teams may be associated with football teams in any particular manner. In some embodiments, for example, a rugby team may be associated with a football team when the rugby and football teams share a geographic area, such as being based in a same city or same state or being based within a threshold distance of one another. In other cases, however, some or all of the rugby teams may not be in operation at a time that the rugby league/teams are associated with the football league/team. In this case, a rugby team may be created by a football team and may be associated with the football team that created the rugby team.

In some embodiments, a rugby team that is associated with a football team may share the resources of that football team. Embodiments are not limited to sharing any particular resource(s) between the rugby team and the football team. In some embodiments, the shared resources may include physical resources and/or human resources. In other embodiments, the shared resources may additionally or alternatively include intellectual property resources, such as trademarks and logos.

In embodiments that share physical resources between the rugby team and the football team, the physical resources may include any suitable physical resource and may be shared in any suitable manner, as embodiments are not limited in this respect. Physical resources of the football team may include tangible objects owned or operated by the football team. The physical resources may include, for example, equipment such as player uniforms and safety equipment, practice equipment, and/or physical facilities. The physical facilities may include a stadium and, as such, in some embodiments sharing the physical resources may include sharing a stadium between the rugby team and the football team. When the stadium is shared, the rugby team may play its games on the same field as the football team, but at different times. For example, the rugby team may play on different days of the week or at a different time of year from the football team. As a specific example, the rugby team may use the shared stadium during the spring and summer and the football team may use the shared stadium during the fall and winter.

In embodiments that share human resources between the rugby team and the football team, the human resources may include any suitable human resources of a professional or semi-professional football team, as embodiments are not limited in this respect. Human resources may include, for example, coaching staff or administrative staff such as health care staff, finance staff, marketing staff, or other people performing operations related to a professional athletic team. In some embodiments, the human resources of the football team shared with the rugby team may include football players of the football team. The football players shared between the football and rugby teams may play for the rugby team at some times and for the football team at other times, for example, for the rugby team in the spring and summer and for the football team in the fall and winter. In some cases, the football players may not have any prior rugby experience. However, in accordance with techniques described herein, the football players may play for the rugby team in positions selected based on the football positions played by those players and based on the skills of those players.

In some embodiments, sharing football players between a football team and a rugby team may include evaluating the positions and skills of football players of the football team to determine which of the players have backgrounds that may be suitable for the rugby team. In some embodiments, each of the players of a football team may be evaluated for whether they demonstrate attributes that signal they might play successfully on a rugby team. In other embodiments, only some of the players of a football team may be evaluated. For example, in some embodiments, only second- and third-string players may be evaluated, and first-string players may not be evaluated. Such an evaluation process may be carried out in any suitable manner, including through an automated (through the use of software executing on one or more computing devices) analysis of statistics and other information on players' backgrounds, positions, and skills. In cases where the evaluation is automated, the evaluation may be done using information stored in a computer data store, such as in a database or any other suitable data structure encoded on one or more computer storage media. The information may include any suitable information about players' backgrounds, including positions currently and/or previously played on football and/or rugby teams, statistics on various skills or achievements of the players (e.g., rushing yards, pass completions, etc.), reviews of players' performances, or other information on players' skills. This evaluation may be conducted in view of a mapping between football skills/positions and rugby positions. Such a mapping may identify football skills/positions that may translate to particular positions on a rugby team. Examples of such football skills/positions and rugby positions that may be used in such a mapping are discussed above in connection with FIGS. 6-9. In some cases, the mapping may indicate that a football position may correspond to multiple rugby positions. In such a case, in some embodiments, the mapping may also indicate a priority between the rugby positions to which the football position corresponds. With such a prioritization, when a football player who plays in that position demonstrates attributes that signal he may be successful at multiple positions, that player may be assigned to a rugby position in accordance with the prioritization.

The evaluation may be carried out in any suitable manner to determine whether a player's skills and positions played satisfy the skills/positions identified by the mapping for any of the rugby positions. The evaluation may therefore be carried out for each of the football players one-by-one or in any other manner. In some embodiments, a scoring system may be used in an automated process to perform the evaluation and to indicate a result of the evaluation. For example, a mapping for a rugby position may indicate one or more football positions and one or more football skills. The football skills may be identified in any suitable manner, such as by minimum statistics. When the evaluation is carried out for a football player and for that rugby position, the football player may be assigned one point for each football position and each skill identified in the mapping for that rugby position. A result of the evaluation for that player and that rugby position may be a sum of the points assigned through the evaluation. Through using such a points system, a higher score for a football player and a rugby position may indicate a higher likelihood that that football player may play well in that rugby position.

Football players may thereby be evaluated through an automated process to identify rugby positions that the football player may advantageously play on in the rugby team associated with the football team for which the football player plays. The evaluation may yield (either through the points system described above or in any other manner) information indicating a suitability of that football player for the rugby position. Where a player is determined to be suitable for a rugby position (e.g., by having a points sum above a threshold), the player may be added to the roster for the rugby team and play for the rugby team in that position. Thus, through use of the type of mapping of football skills and positions to rugby positions described above in connection with FIGS. 6-9, football players may be assigned to rugby team positions and a rugby team roster may be constructed through sharing human resources with a football team.

In addition to or as an alternative to sharing physical and/or human resources, in some embodiments a rugby team may share intellectual property resources, such as trademarks. Such trademarks may include team name and logo. Where the rugby team shares a team name and logo with the football team, the sharing of resources may include manufacturing and distributing (e.g., selling) equipment and marketing materials for the rugby team using a name and logo previously used by the football team. Manufacturing and distributing equipment may include creating uniforms for the rugby team with the football team's name and logo. Manufacturing and distributing marketing material may include manufacturing and distributing merchandise, such as rugby jerseys, rugby balls, or other rugby goods that include the name and logo of the football team.

Accordingly, inventive concepts described herein may be embodied as a method of employing physical and/or human resources for organizing and playing rugby games. Alternatively or additionally, inventive concepts described herein may be embodied as a system for scheduling, organizing or performing such games. Alternatively or additionally, inventive concepts described herein may be embodied as computer-executable instructions recorded in a non-transitory medium to facilitate such scheduling or organizing.

Techniques operating according to the principles described herein may be implemented in any suitable manner. Included in the discussion above are a series of flow charts showing the steps and acts of various processes that associate teams of a football league with teams of a rugby league. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Functional facilities may be developed for carrying out one or more tasks described herein. It should be appreciated, though, that embodiments are not limited to implementing in any specific number, division, or type of functional facilities. In some implementations, all functionality may be implemented in a single functional facility.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 1006 of FIG. 10 described below (i.e., as a portion of a computing device 1000) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 10, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 10 illustrates one exemplary implementation of a computing device in the form of a computing device 1000 that may be used in a system implementing techniques described herein, although others are possible. It should be appreciated that FIG. 10 is intended neither to be a depiction of necessary components for a computing device to operate in accordance with the principles described herein, nor a comprehensive depiction.

Computing device 1000 may comprise at least one processor 1002, a network adapter 1004, and computer-readable storage media 1006. Computing device 1000 may be, for example, a desktop or laptop personal computer, a personal digital assistant (PDA), a smart mobile phone, a server, or any other suitable computing device. Network adapter 1004 may be any suitable hardware and/or software to enable the computing device 1000 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1006 may be adapted to store data to be processed and/or instructions to be executed by processor 1002. Processor 1002 enables processing of data and execution of instructions. The data and instructions may be stored on the computer-readable storage media 1006 and may, for example, enable communication between components of the computing device 1000.

The data and instructions stored on computer-readable storage media 1006 may comprise computer-executable instructions implementing techniques which operate according to the principles described herein. In the example of FIG. 10, computer-readable storage media 1006 stores computer-executable instructions implementing various facilities and storing various information as described above. Computer-readable storage media 1006 may store a data store 1008 of background information on players, as well as a mapping facility 1010 that may evaluate the background information in accordance with a mapping of football positions to rugby positions to determine whether any of the football players demonstrate attributes that signal that one or more of them may specifically fit and play well in certain rugby positions.

While not illustrated in FIG. 10, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method of operating a rugby league within the United States using resources of an American football league, the method comprising:
for each rugby team of a plurality of rugby teams of the rugby league:
associating the rugby team with a football team of a plurality of football teams of the American football league; and
sharing resources of the football team with the rugby team, wherein sharing resources comprises the rugby team playing games with other teams of the plurality of rugby teams using physical resources and human resources of the one football team.

2. The method of claim 1, wherein sharing resources of the football team with the rugby team comprises sharing the human resources of the football team at least in part by:
for one or more football players of the football team, evaluating a position played by the football player on the football team and skills of the football player in connection with a mapping of football positions and skills to rugby positions; and
assigning at least one of the one or more football players to a position on the rugby team based at least in part on the evaluating.

3. The method of claim 2, wherein:
a rugby team comprises a plurality of positions;
the mapping identifies a first plurality of positions on the rugby team as positions that may be filled by football players meeting criteria, the first plurality of positions being fewer than all of the plurality of positions; and
following the assigning, the rugby team comprises football players of the football team in at least some of the first plurality of positions and comprises rugby players who do not play on the football team in other positions of the plurality of positions.

4. The method of claim 3, wherein:
the mapping identifies two or more rugby positions as corresponding to a same one football position; and
the mapping identifies a prioritization among the two or more rugby positions associated with the one football position, wherein the prioritization identifies an order in which football players who play in the one football position should be assigned to the two or more rugby positions.

5. The method of claim 2, wherein the evaluating in connection with the mapping comprises, with at least one programmed processor:
retrieving, from at least one data store, information on a playing background of each of the one or more football players of the football team, the information on the playing background of each of the players identifying, for each player, statistics on skills demonstrated by the player in playing at a football position; and
for each one football player,
scoring the playing background of the one football player based at least in part on the mapping; and
determining whether the scoring meets at least one criteria for the one football player to be considered a match for a position on the rugby team, wherein the position on the rugby team is a position identified in the mapping as corresponding to a football position that the playing background of the one football player indicates is played by the one football player.

6. The method of claim 5, wherein scoring the playing background of the one football player comprises:
determining whether the mapping identifies a rugby position corresponding to the football position identified by the playing background as played by the one football player;
in response to identifying a rugby position from the mapping, identifying, from the mapping and for the rugby position, a set of minimum statistics for each of at least one football skill; and
calculating a score based at least in part on whether the playing background for the one player indicates that the one football player has statistics for each of the at least one football skill that exceed corresponding minimum statistics identified by the mapping.

7. The method of claim 5, wherein the evaluating in connection with the mapping comprises, with at least one programmed processor:
retrieving from at least one data store information on a playing background of each of the one or more football players of the football team, the information on the playing background of each of the players identifying, for each player, statistics on skills demonstrated by the player in playing at a football position; and
for each one football player, determining a suitability of the one football player for a position on the rugby team based at least in part on an analysis of the information on the playing background of the one football player.

8. The method of claim 5, wherein the evaluating in connection with the mapping comprises evaluating information on a playing background of each of the one or more football players of the football team, the information on the playing background of each of the players identifying, for each player, statistics on skills demonstrated by the player in playing at a football position and any prior rugby experience of the player.

9. The method of claim 5, wherein evaluating the one or more football players of the football team comprises evaluating one or more second- or third-string football players of the football team and refraining from evaluating first-string football players of the football team.

10. The method of claim 1, wherein the rugby league is a professional rugby league and the pre-existing American football league is a professional American football league.

11. The method of claim 10, wherein the professional American football league is the National Football League (NFL).

12. The method of claim 1, wherein the rugby league is a semi-professional rugby league and the pre-existing American football league is a semi-professional American football league.

13. The method of claim 1, wherein the American football league is a league that existed prior to the sharing of resources and at least some of the plurality of football teams existed prior to the sharing of resources.

14. The method of claim 13, wherein the rugby league is a rugby league that existed prior to the associating and the sharing of resources and at least some of the plurality of rugby teams existed prior to the sharing of resources.

15. The method of claim 13, wherein:
the rugby league is a rugby league that did not exist prior to the associating and the sharing of resources; and
the associating comprises creating each of the rugby teams of the rugby league at a location that is in a same geographic location in which the football team, with which the created rugby team is associated, was located prior to the sharing of resources.

16. The method of claim 1, wherein sharing the human resources of the football team comprises sharing administrative resources between the rugby team and the football team.

17. The method of claim 1, wherein playing games with other teams of the plurality of rugby teams using physical resources of the football team comprises playing the games in the football stadium of the football team.

18. The method of claim 16, wherein playing games with other teams of the plurality of rugby teams comprises playing games at a different time of year than a playing season of the American football league.

19. The method of claim 1, wherein sharing resources of the football team with the one rugby team comprises sharing trademarks between the football team and the rugby team.

20. The method of claim 1, wherein the rugby league is a rugby union league.

21. At least one computer-readable storage medium having encoded thereon executable instructions that, when executed by at least one processor, cause the at least one processor to carry out a method of operating a rugby league within the United States using resources of an American football league, the method comprising:
for each rugby team of a plurality of rugby teams of the rugby league, associating the rugby team with a football team of a plurality of football teams of the American football league;
for each of one or more football players of a first football team, of the plurality of football teams, with which a first rugby team, of the plurality of rugby teams, is associated:
retrieving, from at least one data store, information on a playing background of the football player, the information on the playing background of the player identifying statistics on skills demonstrated by the player in playing at a first football position; and
scoring the playing background of the football player based at least in part on a mapping of football positions and skills to rugby positions;
determining whether the scoring meets at least one criteria for the football player to be considered a match for a first position on the first rugby team, wherein the first position on the first rugby team is a position identified in the mapping as corresponding to the first football position that the playing background of the one football player indicates has been played by the one football player; and
assigning the football player to the first position on the first rugby team based at least in part on a result of the determining.

22. A method of operating a professional rugby league within the United States using resources of a professional American football league, wherein the professional American football league predates the professional rugby league, the method comprising:
for each one rugby team of a plurality of rugby teams of the professional rugby league:
associating the rugby team with one football team of a plurality of football teams of the professional American football league; and
sharing resources of the one football team with the one rugby team, wherein sharing resources comprises the one rugby team playing games with other teams of the plurality of rugby teams using physical resources and human resources of the one football team, the human resources of the one football team that are shared comprising players of the one football team and further comprising administrative human resources of the one football team, and wherein the sharing resources further comprises sharing intellectual property resources of the one football team with the one rugby team,
wherein playing games with other teams of the plurality of rugby teams comprises playing games at a different time of year than a playing season of the professional American football league,
wherein sharing resources of the one football team with the one rugby team comprises sharing the human resources of the one football team at least in part by:
for one or more football players of the one football team, evaluating a position played by the football player on the one football team and skills of the football player in connection with a mapping of football positions and skills to rugby positions, the one or more football players of the one football team comprising second-string and third-string football players of the one football team and not comprising first-string football players of the one football team, the mapping identifying a first plurality of positions on the one rugby team as positions that may be filled by football players meeting criteria and the first plurality of positions being fewer than all of the plurality of positions on the one rugby team; and
assigning at least one of the one or more football players to a position on the one rugby team based at least in part on the evaluating.

23. A method of operating a professional rugby league within the United States, the method comprising:
at a first time, initiating a roster for a professional rugby team based in a geographic area by recruiting non-professional rugby players playing on a non-professional rugby team in the geographic area to play for the professional rugby team, the non-professional rugby team being a team within a non-professional rugby league and the professional rugby team being a team within the professional rugby league;
at a second time later than the first time, recruiting college rugby players to play on the professional rugby team based in the geographic area; and
at a third time later than the second time, integrating the professional rugby team with a professional American football team based in the geographic area, wherein the professional American football team is a team within a professional American football league, and wherein integrating the professional rugby team with the professional American football team comprises sharing resources between the professional rugby team and the professional American football team, and wherein sharing resources between the professional rugby team and the professional American football team comprises sharing players between the professional rugby team and the professional American football team such that the roster of the professional rugby team includes American football players of the professional American football team.

24. A method of operating a professional rugby league within the United States, the method comprising:
starting the professional rugby league at a first time, wherein starting the professional rugby league comprises starting a plurality of professional rugby teams in a plurality of geographic areas, wherein starting the plurality of professional rugby teams comprises, for at least a first professional rugby teams based in a first geographic area, initiating a roster for the first professional rugby team by recruiting non-professional rugby players playing on at least one non-professional rugby team in the first geographic area to play for the first professional rugby team, the at least one non-professional rugby team being one or more teams within a non-professional rugby league.

25. The method of claim 24, further comprising:
at a second time later than the first time, recruiting college rugby players to play on one or more of the plurality of professional rugby teams.

26. The method of claim 25, further comprising:
at a third time later than the second time, integrating the professional rugby league with a professional American football league, wherein integrating the professional rugby league with the professional American football league comprises, for each one of the plurality of professional rugby teams, integrating the one professional rugby team with one professional American football team of a plurality of American football teams of the professional American football league, wherein integrating the one professional rugby team with the one professional American football team comprises selecting the one professional American football team from the plurality of American football teams based on geographic proximity to the one professional rugby team, and
wherein integrating the one professional rugby team with the one professional American football team comprises sharing resources between the one professional rugby team and the one professional American football team, and wherein sharing resources between the one professional rugby team and the one professional American football team comprises sharing players between the one professional rugby team and the one professional American football team such that the roster of the one professional rugby team includes American football players of the one professional American football team.
